(19) United States
(12) Patent Application Publication
(10) Pub. No.: US 2011/0125468 A1
(43) Pub. Date: May 26, 2011

(54) USING RESPONSE SURFACES FOR SCREENING INHIBITOR COMBINATIONS AND DIGITAL PROCESSING METHODS

(75) Inventors: Jonathan Basil Fitzgerald, Cambridge, MA (US); Brian Harms, Roslindale, MA (US)

(73) Assignee: Merrimack Pharmaceuticals, Inc., Cambridge, MA (US)

(21) Appl. No.: 12/912,567

(22) Filed: Oct. 26, 2010

Related U.S. Application Data
(60) Provisional application No. 61/255,023, filed on Oct. 26, 2009.

(51) Int. Cl. G06F 17/10; G06G 7/60

(52) U.S. Cl. 703/2; 703/11

(57) ABSTRACT

A method for selecting a combination of therapeutic agents can include: providing a response surface having data that relates network activation states of a downstream component of a biological network with activation states of at least two upstream components of the network; identifying a desired network activation state of the downstream component from the response surface; identifying the corresponding activation states of the upstream components and identifying at least two therapeutic agents that modulate the upstream components and that are capable of obtaining the desired network activation state. The response surface can be visual or virtual. Optionally, the desired network activation state is an optimal network activation state.

### CROSS-REFERENCE

The present application claims benefit of U.S. Provisional Application 61/255,023, filed on Oct. 26, 2009, which provisional application is incorporated herein by specific reference in its entirety.

### BACKGROUND OF THE INVENTION

Drug discovery is the process by which drugs are discovered and/or designed. Typically, modern drug discovery involves identifying an attractive biological target, understanding the biology of that target at the molecular and physiological level, and screening and selecting possible therapeutic agents against that target based on this knowledge. It is customary in this modern approach to perform large numbers of experimentally intensive screens in order to identify and select novel therapeutic agents. For example, GLEEVEC®, a small molecule inhibitor of tyrosine kinases, was selected from a large panel of molecules based on ability to inhibit particular kinase activities.

The various aspects of cellular physiology, e.g., cellular growth and division, are precisely regulated by biological networks typically signaling networks, that are modulated by extracellular stimuli and intracellular conditions. Selective inhibition of biological network(s) that are involved in promoting cell proliferation is a therapeutic strategy that can now be implemented by treatment with drugs specific to particular elements of such biological networks. Recently developed methods enable discovery of drugs that are targeted to critical components of biological networks involved in cell proliferation. Since multiple biological network pathways are abnormally activated in typical cancer cells, it can be difficult to adequately and effectively treat cancer by targeting only one critical network component. For example, inhibiting a downstream network function by inhibiting one upstream component may be ineffective, or may lose efficacy, when another network pathway is active or becomes activated. Thus, single drug therapies that are effective (particularly during longer-term treatment) can be difficult to achieve. The use of multiple drugs to target multiple biological pathways for inhibition may be more advantageous, and thus combination therapies may be desirable or necessary in certain instances. Previously, combination therapies have been developed by combining existing therapies ad-hoc, with low rates of success.

It is thus apparent that, despite many clinical successes in the development of targeted anti-cancer therapies, for many tumor types nearly all patients either are de novo resistant to single-agent targeted therapies, or become resistant after therapy is commenced. Often, this is because additional cellular growth occurs due to the activation of additional mechanisms (e.g., network pathways) that are not targeted by the therapy. In particular, inhibition of biological signaling networks which, when active, play important roles in the expression of neoplastic cellular phenotypes, is circumvented by activation of other biological signaling networks. As such, there is great need for improved methods to effectively develop combination therapies for modulating cellular phenotypes such as excessive cell proliferation.

Typical combination therapies come about from ad hoc experimental (e.g., clinical) studies usually combining a known active agent with a second (e.g., novel) agent in the hope of seeing an additive or synergistic effect. Designing a combination therapy with two or more novel agents is especially challenging as the actions of each agent may impact the effectiveness of the other agents in the combination. Therefore, to determine the most effective combination, all possible combinations should be experimentally tested which, especially for the case of multiple novel agents, can be experimentally impracticable. Accordingly, methods are needed to predict which combinations of therapeutic agents will provide combination therapies that are most likely to provide beneficial outcomes.

Modern drug discovery has begun to see the application of computational modeling approaches to identify cellular targets for new drugs. For example, Merrimack Pharmaceuticals, Inc., used a computational modeling of the ErbB pathway to identify ErbB3 as a central node in the pathway regulating downstream cellular survival signals. Merrimack then used a model-guided approach to develop MM-121, an ErbB3 antagonist. Applying pathway simulation approaches to combination therapies may also be possible; however, model complexity increases dramatically when multiple pathways are involved—a problem currently being tackled by ground-breaking academic research. Combinations of computational models have been used; however, it is technically very difficult to merge multiple models in order to develop a single model for a combination therapy.

Generally, drug discovery approaches have attempted to understand how disease and/or infections are propagated and/or combated at the molecular and physiological level, and to utilize potentially therapeutic agents against specific entities involved in the disease and/or infection state based on this knowledge. The process of drug discovery can involve the synthesis and/or identification of candidate drugs, characterization, screening, and assays for therapeutic efficacy of the candidate drugs. Such processes typically require testing in cells and animals, are cell culture intensive, and require a great deal of experimentation on living cells in order to determine the effectiveness of a particular compound.

Often, the process of finding a new drug against a chosen target for a particular disease involves high-throughput screening (HTS), where large libraries of chemicals are tested for their ability to modify the functionality of the chosen target in a therapeutically beneficial manner. For example, if the target is a cell surface receptor involved in a particular biological pathway, compounds will be screened (e.g., by HTS) for their ability to inhibit or stimulate that receptor. Usually, compounds for use as drugs are inhibitors of protein function, such as receptor function, so that a network comprising the protein is inhibited, e.g., shut down. HTS assays are often implemented with cell cultures, and thereby require a substantial amount of time in the preparation of cells, performance of experiments, and interpretation of data obtained from the cells.

Combination drug therapies, which are essentially combinations of single drugs, have been investigated for the treatment of particular diseases. Often, the combination of drugs target particular protein Targets of a biological network involved in a disease. Traditional drug combination investigations have been performed similarly to the drug discovery techniques described above. This includes screening a large number of drugs in combinations which results in an even larger number of assays than are required for drug discovery. Such brute force screening techniques are time consuming and expensive, especially when considering all of the drug combination permutations that would need to be investigated. As such, intensive cell culture-based experiments have been required in order to determine whether a drug combination is suitable and optimal for a particular disease.

Recently, data processing technologies and associated computer models have advanced to a point where a model, supplemented with experimental data, can be used in drug discovery. Digital processing computer models can be useful for drug discovery when a computer model accurately reflects the experimental data observed with the actual use of a potential drug. Accordingly, the more accurate a computer model, the more accurate the data obtained from digital processing simulations using the model. Often, the models that accurately reflect experimental data in a manner suitable for use in drug discovery are exceedingly complex. The complexity arises from accurately defining the interaction of various components of a biological pathway as well as the perturbation of a potential drug on the various components of the biological pathway. Response surface methodology is a set of mathematical and statistical tools and techniques that facilitate determination of optimal responses that may be obtained through variation of multiple independent variables. See, e.g., Response Surface Methodology: Process and Product Optimization Using Designed Experiments, 3^{rd}. ed. by Myers, Montgomery and Anderson-Cook, Wiley, 2009, ISBN: 0470174463; and RSM Simplified: Optimizing Processes Using Response Surface Methods for Design of Experiments by Anderson and Whitcomb, Productivity Press, 2005, ISBN: 1563272970.

There remains a need for improved methods of identifying useful drug combinations for therapeutic use.

### BRIEF SUMMARY OF THE INVENTION

In one embodiment, the present invention provides a method for selecting a combination of a plurality of therapeutic agents. Such as method can include: providing (i.e., constructing, creating, preparing, or generating; e.g., calculating from empirical data or simulating using a mathematical model) a response surface having (i.e., constructed, created, prepared, or generated using empirical or simulated) data that relates the activation state of a downstream biological target (“downstream component”) of a biological network with activation states of at least two upstream components of the biological network; identifying a desired cellular network activation state (“NAS”) correlated with the activation state of the downstream component from the response surface; identifying the possible corresponding activation states of the upstream components that achieve the activation state of the downstream component; and identifying at least two therapeutic agents capable of modulating the upstream components to their desired level, and so obtaining the desired NAS. The response surface can be visual or virtual. Optionally, the desired NAS is an optimal NAS.

In one embodiment, a method is provided for selecting a combination of a number of candidate therapeutic agents, said number constituting a plurality, which selected combination is capable of mediating, in a cell, a change of an activation state of a first upstream component of a biological network within the cell and a change of an activation state of at least a second upstream component of the biological network, the changed activation states of the upstream components that the selected combinations are capable of mediating in turn altering an activation state of at least one downstream component of the biological network, which altered activation state of the at least one downstream component is capable of promoting a therapeutically advantageous network activation state (“NAS”) of the biological network, the method comprising:

a) providing a response surface having a plurality of axes, each first such axis having data that relates an activation state of said at least one downstream component with activation states of the first upstream component, each second such axis having data that relates an activation state of said at least one downstream component with activation states of a second upstream component of the biological network, and each nth axis, if present, having data that relates an activation state of said at least one downstream component with activation states of the nth upstream component, if present, wherein the plurality of axes is equal in number to the number of candidate therapeutic agents to be in the selected combination;

b) providing pharmacologic data describing, for each member of a first plurality of candidate therapeutic agents, a first data set representing at least one first degree of impact of the member of the first plurality of candidate therapeutic agents on an activation state of the first upstream component, for each member of a second plurality of candidate therapeutic agents, a second data set representing at least one second degree of impact of the member of the second plurality of candidate therapeutic agents on an activation state of the second upstream component, and for each member of an nth plurality of candidate therapeutic agents, if present, an nth data set representing at least one nth degree of impact of the member of the nth plurality of candidate therapeutic agents on an activation state of the nth upstream component (wherein nth refers to successive integer quantities),wherein said first and second, and, if present, nth pluralities contain sets of candidate therapeutic agents that may be overlapping or non-overlapping with each other first, second, or nth set of candidate therapeutic agents present;

c) mapping the pharmacologic data describing each first degree of impact as a data point on the first axis of the response surface, mapping the pharmacologic data describing each second degree of impact as a data point on the second axis of the response surface, and mapping, if one or more nth pluralities are present, the pharmacologic data describing each nth degree of impact as a data point on, the nth axis of the response surface, so that all combinations of first, second, and, if present, nth, data points are mapped as specific sets of response surface coordinates, wherein each specific set of response surface coordinates represents a predicted effect of each corresponding combination of therapeutic agents on the activation state of the downstream component;

d) delineating a defined set of therapeutically advantageous activation states of the downstream component as a contiguous or discontiguous area on the response surface;

e) identifying those combinations of first, second, and, if present, nth candidate therapeutic agents the specific set of response surface coordinates for which map within the contiguous or discontiguous area on the response surface; wherein, each combination of candidate therapeutic agents so identified is selected as a combination that can act together achieve a network activation state within the defined set. In certain embodiments the nth component is present as a third component and there are only three components. In others the nth upstream component is present as a third upstream component and a fourth upstream component and there are only four upstream components. In yet others the nth upstream component is present as a third upstream component and a fourth upstream component and a fifth upstream component and there are only five upstream components. In other embodiments there are more than five upstream components.

In certain embodiments, there is no nth component present, and all combinations of first and second, data points are mapped as specific response surface coordinates by projecting, from each data point on the first axis of the response surface, a first line that is orthogonal to the first axis; and projecting, from each data point on the second axis of the response surface, a second line that is orthogonal to the second axis, which first and second lines intersect on the response surface so as to generate a plurality of intersections between each orthogonal line from each data point for each member of the first plurality of therapeutic agents and each orthogonal line from each data point for each member of the second plurality of candidate therapeutic agents, wherein each intersection corresponds to a particular pair of candidate therapeutic agents and location of each intersection on the response surface represents a predicted effect of each pair of therapeutic agents on the activation state of the downstream component.

In any of the embodiments disclosed herein, at least one of the selected combinations is tested in a cell-based assay to determine of it is capable of promoting the therapeutically advantageous network activation state of the biological network. In certain of such embodiments, the therapeutically advantageous network activation state is one that results in inhibition of cell proliferation and the selected combinations are tested in cell-based assays for inhibition of cell proliferation.

In certain embodiments, the network activation state of the biological network is determined by measuring a cellular property or event indirectly related to the network activation state.

In certain embodiments, the response surface is a visual response surface and in others the response surface is a computer generated virtual response surface. IN other embodiments the response surface is symmetric or asymmetric.

In certain embodiments, the plurality of candidate therapeutic agents are part of a library of compounds.

In further embodiments in which there is no nth component present (i.e., there are only two upstream components), the method further includes, prior to mapping the pharmacologic data on the response surface, providing a mathematical model that is capable of simulating the effects of the candidate therapeutic agents on the first and second upstream components, the mathematic model including at least one avidity criterion as a parameter to join each pair of candidate therapeutic agents; wherein, for each avidity criterion included in the model, each pair of candidate therapeutic agents so identified is selected as a pair that can act together in a bispecific molecule (a “bispecific”) to achieve a network activation state within the defined set. In certain of these embodiments, at least one pair of the selected combinations is tested as a bispecific in a cell-based assay to determine of the bispecific is capable of promoting the therapeutically advantageous network activation state of the biological network. In others, both the first and second candidate therapeutic agents together are modulators, activators, or inhibitors to one or more of the first or second upstream components. Ion yet other such embodiments, each candidate therapeutic agent is selected from the group consisting of small molecules, polypeptides, polynucleotides, siRNA, antibodies, Fabs, ScFvs, proteins, genes, bispecifics thereof, and combinations thereof. In yet others, the bispecific molecule comprises the first candidate therapeutic agent and the second candidate therapeutic agent coupled together through a linker.

In yet another embodiment, the method can include correlating said desired NAS to a desired activation state of each of the upstream components, wherein the identified therapeutic agents are capable of obtaining the desired activation states of the upstream components. The method can also include performing experiments to determine the activation states of the upstream components of the biological network in response to stimuli (e.g., activation or inhibition) of the respective upstream components. Additionally, the method can include performing experiments to obtain the activation state(s) of the downstream component(s) in response to the activation states of the upstream components.

In one embodiment, the method can include identifying a starting activation state of the downstream component on the response surface; and identifying a change in the activation state of the downstream component from the starting activation state to the desired activation state. The desired endpoint activation state of a downstream component can then be located on the response surface can be correlated with a change in the activation states of the upstream components, thereby identifying properties of drugs that, when administered in conjunction with each other, would provide useful combination therapy.

In one embodiment, the data is simulated in a computing system with one or more mathematical models of the biological network. In another embodiment, the data is empirically derived experimental data.

In one embodiment, the combination of therapeutic agents can reduce the NAS of the downstream component below a desired threshold.

In one embodiment, the therapeutic agents have an additive or synergistic effect on the NAS of the downstream component. The result could also be the reduction of the NAS to below a desired threshold. In one embodiment, the therapeutic agents have a synergistic effect on the NAS of the downstream component. The result could also be the reduction of the NAS to below a desired threshold. In one embodiment, the concentrations at which each of the therapeutic agents can reduce the NAS of the downstream component below a desired threshold, via modulation of the upstream components, are used as selection criteria to identify effective drug combinations.

In one embodiment, the desired NAS is related to activation, inhibition, phosphorylation, or other modulation of the downstream component. The data of the desired NAS of the downstream component can be obtained by measuring or identifying a property or event indirectly related to the downstream component. The property or event indirectly related to the downstream component can be cell proliferation, or a property or event of another component of the biological network other than the downstream component or the at least two upstream components.

In one embodiment, the identified desired NAS of the downstream component is located up or down a steepest gradient on the response surface. In some instances the response surface is symmetric. In other instances the response surface is asymmetric.

In one embodiment, the at least two therapeutic agents are part of a library of compounds. As such, the method can include screening a plurality of compounds of the library of compounds with the response surface.

In one embodiment, the present invention can include another method for selecting a combination of therapeutic agents. The method can include: providing a response surface having data that relates NASs of a downstream component of a biological network with activation states of at least a first component and second component of the biological network that are upstream of the downstream component; identifying a starting NAS of the downstream component and corresponding activation states of the first and second components on the response surface; identifying a change in the NAS of the downstream component that is along a gradient of the response surface from the starting NAS to a desired NAS; identifying a change in the activation states of the first and second components related to the change in the NAS; and identifying at least a first therapeutic agent and second therapeutic agent capable of changing the activation states of the first and second components to provide the desired NAS of the downstream component. The method can also include identifying an amount of at least the first and second therapeutic agents capable of achieving the desired NAS. The response surface can be visual or virtual. Optionally, the desired NAS is an optimal NAS.

In one embodiment, the method can include obtaining data from one or more experiments to obtain the activation state of the first upstream component in response to a natural ligand thereof; and/or obtaining data from one or more experiments to obtain the activation state of the second upstream component in response to a natural ligand thereof. Also, the method can include obtaining data from one or more experiments to obtain the NASs of the downstream component related to the activation states of the first upstream component; and/or obtaining data from one or more experiments to obtain the NASs of the downstream component related to the activation states of the second upstream component. Also, the data can be at least partially simulated by a computing system with one or more mathematical models of the biological network.

In one embodiment, the method can include: generating a response curve of the activation states of the first upstream component in response to changes in the natural ligand thereof; and/or generating a response curve of the activation states of the second upstream component in response to changes in the natural ligand thereof. The method can also include generating a checkerboard dose matrix for the first and second upstream components, whereby each dose of the first of the first natural ligand is combined with each dose of the second natural ligand and both the first and second upstream components are measured. A common downstream readout would also be measured (i.e. pAkt, proliferation).

In one embodiment, the first and second therapeutic agents can have a synergistic effect on the NAS of the downstream component. Also, the therapeutic agents can reduce the NAS of the downstream component below a desired threshold. The desired threshold can be selected based on Bliss independence.

In one embodiment, the desired NAS can be related to activation, inhibition, phosphorylation, or other modulation of the downstream component. Also, the data of the desired NAS of the downstream component can be obtained by measuring a property or event indirectly related to the downstream component. As such, the property or event can be indirectly related to the downstream component is cell proliferation, or a property or event of another component of the biological network other than the downstream component or the first and second upstream components.

In one embodiment, the identified desired NAS of the downstream component can be located up or down a steepest gradient on the response surface. The response surface can be symmetric or asymmetric.

In one embodiment, each therapeutic agent is one of a modulator, activator, or inhibitor to one or more of the first or second components. For example, the therapeutic agent can be selected from the group consisting of small molecules (i.e., molecules of no greater than about 500 daltons in mass), polypeptides, polynucleotides, siRNA, antibodies, Fabs, ScFvs, proteins, genes, bispecifics thereof, and combinations thereof. Optionally, the first therapeutic agent and second therapeutic agent are coupled together and form a bispecific.

In one embodiment, the method can include obtaining a plurality of response surfaces for a plurality of cells.

In one embodiment, the present invention can include a method for selecting a bispecific therapeutic agent. Such a method can include: providing a response surface having data that relates NASs of a downstream component of a biological network with activation states of at least a first component and second component of the biological network that are upstream of the downstream component; providing a mathematical model that is capable of simulating the response surface, said mathematic model including avidity as a parameter; identifying a starting NAS of the downstream component and corresponding activation states of the first and second components on the response surface; identifying a change in the NAS of the downstream component that is along a gradient of the response surface from the starting NAS to a desired NAS with regard to the avidity parameter; and identifying at least a first therapeutic agent and second therapeutic agent capable of changing the NAS to provide the desired NAS of the downstream component with regard to the avidity parameter, said first and second therapeutic agents being selected for preparing the bispecific therapeutic agent. The avidity parameter can be estimated to be zero or any other positive number.

These and other embodiments and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a schematic representation of a biological pathway with interacting biological networks.

FIG. 1B is a schematic representation of a mechanistic model connecting upstream components and downstream components for the biological pathway of FIG. 1A.

FIG. 2A is a graphical representation of a two-dimensional (2D) dose matrix based on the phosphorylation of IGF1R to yield phospho-IGF1R (pIGF1R) on the Y-axis and the phosphorylation of ErbB3 to yield phospho-ErbB3 (pErbB3) on the X-axis.

FIG. 2B is a graphical representation of a response surface generated from the two-dimensional dose matrix graph of FIG. 2A, where the activation of the upstream components are the X and Y axis, and the activation of the downstream component is represented by the contour surface.

FIG. 2C is a graphical representation of the role that the response surface in FIG. 2B has in connecting the upstream components and the downstream components in FIG. 1A in place of a mechanistic model in FIG. 1B.

FIGS. 3A-3C show a series of graphs of dose response curves that can be used in preparing a response surface.

FIGS. 4A and 4B show a response surface and illustrate a method of using the response surface to identify a therapeutic combination.

FIGS. 5A-5B are graphical representations of data obtained from the response surface of FIGS. 4A-4B.

FIG. 5C is a graphical representation of a response surface having a synergy sweet spot.

FIGS. 6A and 6B show a response surface and illustrate a method of using the response surface to identify a therapeutic combination.

FIGS. 7A-7E show a series of response surfaces and illustrate methods of using the response surface to identify a therapeutic combination.

FIGS. 8A and 8B show two graphs of dose response curves for ScFvs that can be used in preparing a response surface.

FIG. 9A is a schematic representation of a bispecific therapeutic.

FIG. 9B shows a response surface and illustrates a method of using the response surface to identify a bispecific therapeutic.

FIG. 9C is a graphical representation of data obtained from the response surface of FIG. 9B.

FIGS. 10A-10C show a series of response surfaces and illustrate methods of using the response surfaces to identify a therapeutic combination.

### DETAILED DESCRIPTION OF THE PREFERRED EMBODIMENTS

Generally, the present invention relates to the use of experimental data or data derived from digital processing of computer models to identify an optimal combination of therapeutically active agents that operate in the biological network. The experimental and simulated data can be obtained to show a biological network activation state (e.g., degree of activation of a particular downstream component in a biological pathway) with regard to the modulation of different components in the biological network that impact the status of the network activation state. The network activation state is determined by the activation state of the downstream component. In turn, the network activation state can be used in order to identify an optimal combination of therapeutically active agents that operate in the biological network to achieve the network activation state by modulating the different components in the biological network. More particularly, the use of data (e.g., experimental/simulated) that relates to the modulation of distinct components in a biological network can provide a response surface that can be used to identify optimum combinations of therapeutically active agents that individually target the different components in order to favorably modulate the entire biological network or selected portions thereof to achieve the desired network activation state.

The therapeutic agents that can be identified for a combination therapy can include agonists, antagonists, or inhibitors to the downstream component. Accordingly, the therapeutic agents can be selected from the group consisting of small molecules, drugs, polypeptides, polynucleotides, siRNA, antibodies, Fabs, ScFvs, proteins, genes, bispecifics thereof, and combinations thereof. The therapeutic agent may also be a stimulus (i.e. ligand) which activates the biological network.

The individual therapeutic agents can be the stimuli used as a means of generating data to identify how the first and second upstream components are individually modulated, which are the axis of the response surface. Then the response surface is used for screening the effects of the therapeutic agents on the downstream component to find a combination of therapeutic agents that can achieve a desired or optimal network activation state.

### I. Response Surfaces

A response surface explores the relationships between several explanatory variables and one or more response variables. A response surface can use a set of designed experiments to obtain an optimal response. Typically, a response surface can be 2-dimensional (2-D) having an X-axis and Y-axis of explanatory variables, and a gradient response surface with respect to the X and Y axes. The gradient may also be expressed as a third dimension so that the graph is visually 3-dimensional (3-D). However, a response surface can be configured to have more than two explanatory variables, and the resulting response surface can have any number of axes. It is possible that a response surface can have up to n-axes. When a response surface has more than 2 explanatory variables, it may be beneficial to utilize a virtual response surface rather than a visual response surface due to the limitations of visualization with human eyes. Accordingly, the virtual response surface can be computer generated and information can be obtained from the virtual response surface using digital processing.

Response surfaces can be created and used in order to explore the relationships between several changeable variables and one or more response variables. A response surface can be created from data obtained from a set of experiments or digitally processed models of biological pathways. As such, the data used to construct a response surface may be obtained from an experiment performed for the purpose of analyzing the biological effect of a modulated component of a biological pathway, for generating a response surface, or from literature data obtained for any reason. The response surface can be generated using the data obtained from separate simulations or separate experiments that correlate an activation state of a downstream component with respect to two or more upstream components of a biological network that includes the downstream component. The data can then be utilized to prepare a response surface so that a combination drug therapy can be identified and/or optimized.

A response surface can be used to find the theoretical optimal biological response of the downstream component that is achieved from modulating two or more biological components of the biological network. Usually, the modulating is via activation and/or inhibition. The activation and/or inhibition of the two or more biological components that achieves the optimal biological response of the downstream component can then be used to predict potential combinations of therapeutic agents. The optimal biological response may be achieved by a range of concentrations of therapeutic agents; therefore, the response surface can be used to predict the minimum concentration of therapeutic agents in potential combinations necessary to reach the desired network activation state. The therapeutic agents can be active (e.g., inhibiting or activating) with respect to a combination of receptors involved in the biological pathway. The response surface, which can be described as a contour plot when visual or a database when queried, can then provide information regarding any advantage that may be obtained from using the combination of therapeutic agents over any affect that may be merely additive.

In one embodiment, the present invention includes a method for generating a response surface of an activation state of a biological network. The activation state can be positive activation or negative activation (e.g., inhibition), and such terminology should be considered when reviewing the examples. As such, the activation state may also be considered a modulation state where the biological network is modulated by activation or inhibition. In any event, the use of activation terminology employed herein is merely provided for examples.

The activation state can include the activation of one or more components of the biological network or in a larger, more complex biological network. Such a method can include obtaining data in response to modulating at least a first component and second component of the biological network. While activation of first and second components are described herein with regard to a 2-D response surface, more then 2 components can be assessed for modulation. The first component and second components each have an activation state that influences the activation state of at least one downstream component of the biological network. Optionally, the method can include generating a 2-D dose matrix for the activation states of the first component and second component in response to modulation by natural agonists (e.g., ligands) of the first and second components. The activation states can be obtained from experimental data, previously published data, or simulated data obtained from running algorithms or models of the biological network. The 2-D dose matrix can be used to identify the data to be obtained for generating the response surface. The response surface can then be generated to identify the network activation state for the component activation states identified with the dose matrix. The response surface shows the network activation state in relation to the activation states of the first and second components.

The response surface provides information of the change in an activation state of the downstream component of the biological network, which is considered the network activation state or a representation thereof. For example, the modulation of the downstream component can be phosphorylation of the downstream component or inducing another measureable change related to the downstream component, such as cell death, cell growth, or the phosphorylation or other modulation of a related protein.

In one embodiment, the method of preparing a response surface includes generating a visual representation of the response surface. For example, the visual representation of the response surface is generated on a computer screen, paper, projected image, or combinations thereof. The appearance of the response surface can be similar to a standard two dimensional X-Y graph or 3-D graph with the activation level of the first and second components being on the X and Y-axes and the activation level of the downstream component being graphed as a response surface or in the Z-axis. However, other modifications of visually representing the graph can be used. In some instances, the response surface is digital and visible to computer components. Also, a visual representation of the response surface can be prepared as a graphical illustration having more than the X-Y axes when more than two components of the biological network are studied in connection with the activation state of the downstream component.

The response surface can also be generated as a virtual response surface. A virtual response surface can include a data set that is suitable for use in preparing a visual response surface; however, the data is available in a query format or other digital processing format rather then a visual format. As such, the activation state of the downstream component can be queried for the activation states of the first and second components (or more components if more than 2-D). A computing system can then analyze the data and provide the desired downstream output upon the proper query.

Due to the limitations of the human eye and mind, the response surfaces described herein are being represented as dual agent stimulated response surfaces, however more than two agents can be used in this method. The use of digital processing can allow for multi-dimensional response surfaces. A digital response surface can prepared by imputing data into a computing system, and then inputting the desired query in order for the computing system to provide the downstream output. Accordingly, the virtual response surface having “n” inputs can be represented by a function that has one output, which is the network activation state that is dependent on the activation of the “n” inputs or “n” components being monitored. The number of inputs identifies the number of axes in the response surface, and the output is the value of the response from the function. For example, “n” can be 2, more than 2, up to 10, up to 20, or more if needed or desired.

### A. EXPERIMENTALLY-DERIVED RESPONSE SURFACE

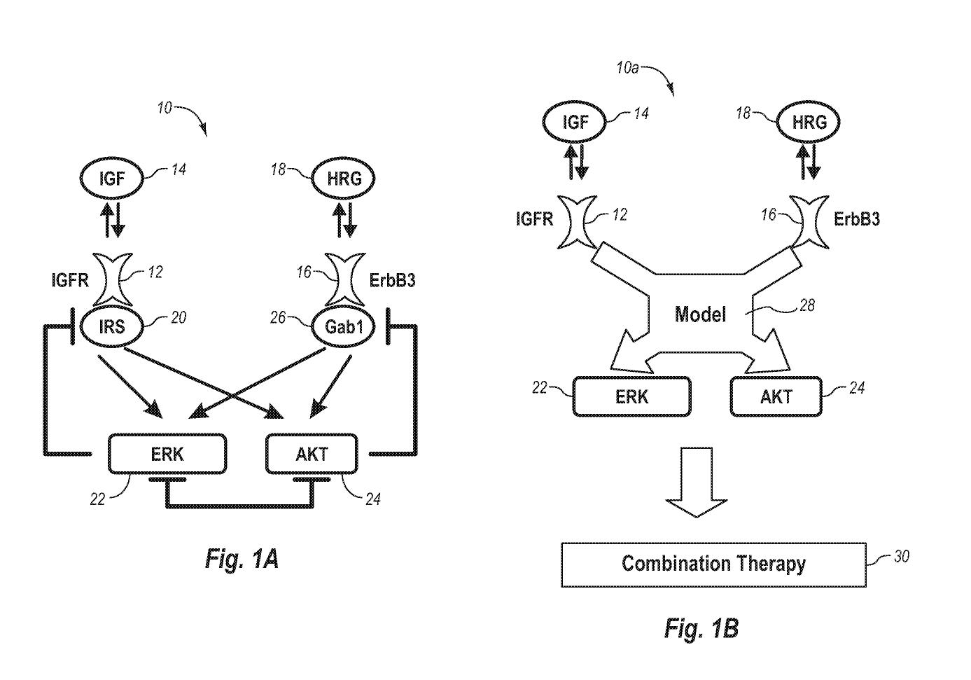

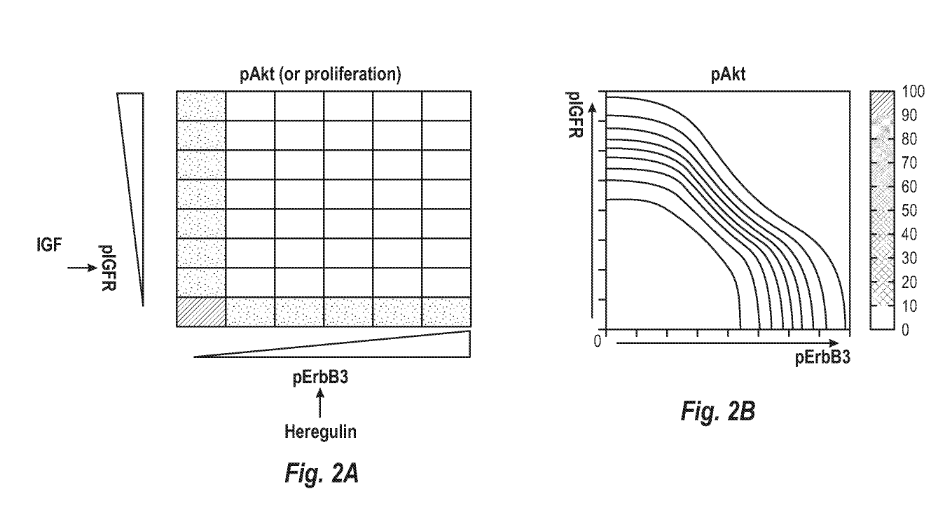

A benefit of the present invention is the ability to obtain data of an activated state of a downstream component without having to process complicated mathematical models. As described herein, the response surface can be prepared from experimental data. As such, a non-mechanistic approach can be utilized in order to predict a combination therapy. A response surface can be used to identify the biological effect to be achieved by the combination therapy. A response surface can be generated from experimental data in order to estimate the downstream signaling of the biological network. The response surface can be used for a biological network (FIG. 1A) instead of a complex mathematical model, and thereby the response surface can predict a combination therapy for a complex regulatory network that transmits signals from the receptor level to the downstream network activation state. The response surface can be experimentally generated based on an understanding of the components of a biological network.

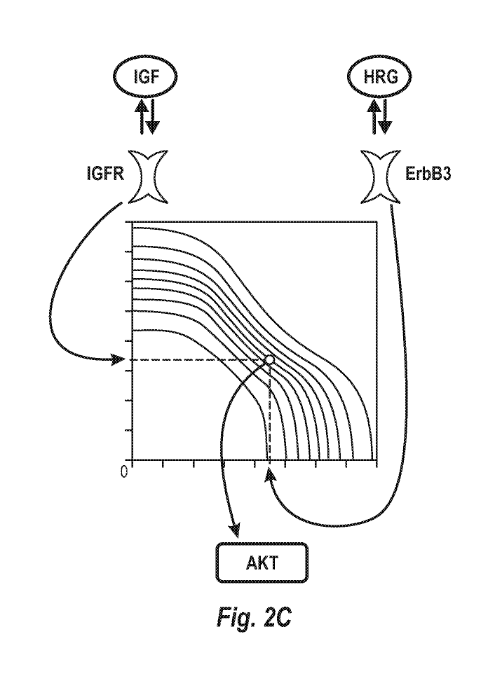

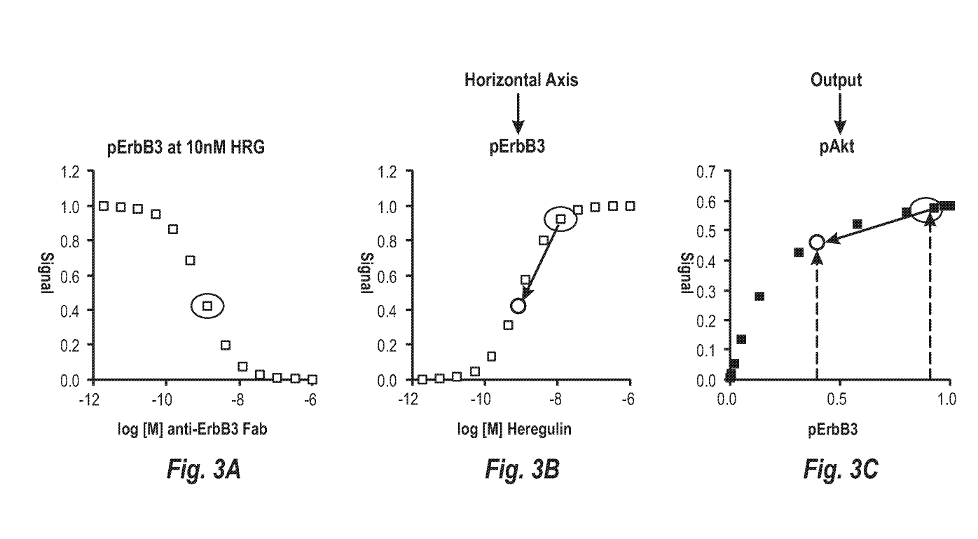

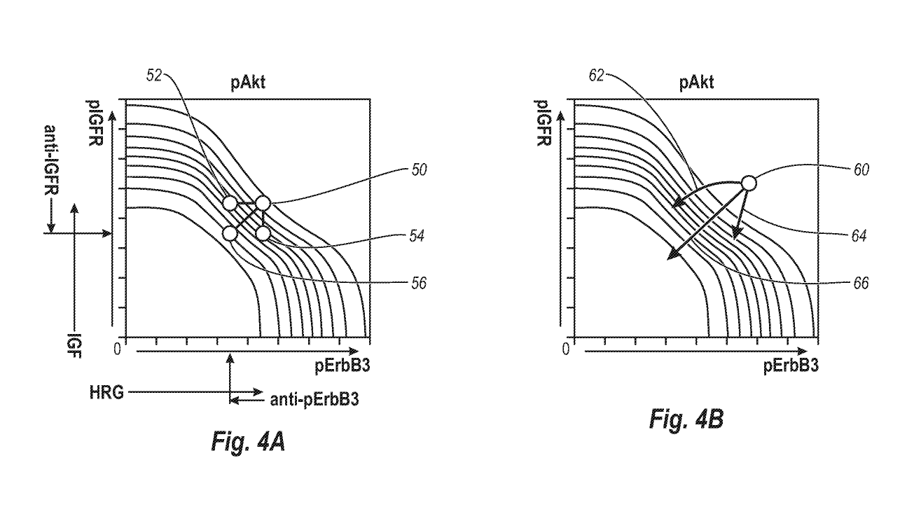

When the biological network of FIG. 1A is considered, a cell line that expresses both IGFR and ErbB3 can be used to generate the experimental data for the response surface. Also, it may be advantageous to use multiple cell lines to get a better estimation of the response of modulating the components of the biological network. A checkerboard dose matrix can be generated with regard to the combination of heregulin (HRG) and IGF ligands that would activate IGFR to phosphorylated IGFR (e.g., pIGFR, activated component) and activate ErbB3 to phosphorylated ErbB3 (e.g., pErbB3, activated component) (FIG. 2A) pathways and the biological network. Each square represents a possible experiment to be performed. The checkerboard dose matrix can provide a roadmap for the experiments to be conducted, where 36 squares are shown, The experiments are conducted to obtain data related to the activation state of Akt (e.g., a downstream component), which is phosphorylated Akt (e.g., pAkt). However, the data of a network activation state can be the phosphorylation of Erk (e.g., pErk), cell proliferation, other measurable event, or the like. The downstream effect can be assayed for the activation state of the downstream component (e.g., pAkt) with regard to the activation states of pIGFR and pErbB3. The data regarding the component activation states and the network activation state can then be graphed in a contour plot, which is a response surface. The response surface can be visually graphed as shown in FIG. 2B or a corresponding 3-D graph with the response in the Z-axis.

The pErbB3 and pIGFR values can be measured to obtain data to serve as inputs into the response surface. The ligand (e.g., HRG and IGF) doses and time point(s) can be measured as guided by separate pathway models of the biological network for both ligands and experimental data that are available or obtainable for IGFR and ErbB3 signaling.

For example, experiments are performed to identify what the change is on the components, such as phosphorylated IGFR and phosphorylated ERB3, and then from that the downstream output is measured for each point. The downstream output identifies what the pAkt is.

For example, the stimuli in the figures include HRG and IGF and are used as a means of generating data to build the response surface. Then the response surface is used for the screening therapeutic agents that can achieve a desired or optimal network activation state. When the stimuli are agonists of the components and increase activation of the downstream component, the response surface can be used to identify combination therapies of inhibitors by moving down the gradient of the response surface. On the other hand, the response surface can be used to identify combination therapies of other agonists by moving up the gradient of the response surface.

In another example, substances in the body that function as natural agonists of receptors in different pathways of a biological network can be used as stimuli. The properties of those substances are used in order to generate the response surface for the activation of a downstream component. Then the response surface is used to identify novel combinations of antagonists for those receptors that end up having a downstream effect on the downstream component (e.g., Akt). Potential combination therapies using antagonists are identified by their ability to decrease the upstream readouts and thereby decrease the downstream component, causing a downwards shift across the response surface. This downward shift could be along the gradient of the response surface, which represents the optimal path (based on minimize dose of agents). However, combination therapies could also be identified by their ability to reduce the downstream component to below so predefined threshold level.

In the inverse, antagonists of the receptors can be used in preparing a response surface of the activation of the downstream component, and then the response surface can be used to identify the agonists of the receptors that achieve the activation state of the downstream component. Here, the agonists are identified by moving down the gradient of the response surface. It is possible that by moving up the gradient of this response surface, combination therapies of other antagonists of the receptors can be identified.

In another example, ligands that are agonists of the receptors can be used for preparing a response surface as described herein. For example, natural agonists like IGF and the like can be used to prepare the response surface. The response surface can then be used to identify other agonists that may be useful. As such, the response surface can be used as a lookup table for other agonists.

### B. SIMULATED RESPONSE SURFACE

The present invention includes digital systems and processes related to the use of digital processing of distinct computer models for different components in a biological network in order to identify an optimal combination of therapeutically active agents that operate in the biological network to obtain a desired result or therapy. The use of data obtained from digital processing of distinct computer models for distinct components in a biological network can provide response surfaces that indicate optimum combinations of therapeutically active agents (i.e., therapeutics) that individually target the distinct components in order to favorably modulate the entire biological network or selected portions thereof. Accordingly, a response surface, or virtual response surface, can be created from the data of two or more separate model simulations for two or more separate therapeutics.

The response surfaces can be created using a mechanistic model that processes experimental data to simulate single or multiple biological networks and/or pathways. The response surface can be prepared by assessing in silico biological components at various points in the biological pathway and/or network. The response surface can provide a theoretical activation state of a downstream component in response to a few to all possible pairwise combinations of effects of in silico components. The response surface can provide the theoretical activation states of components of the biological network that are associated with the theoretical activation state of the downstream component. The theoretical activation states can be used to identify individual therapeutic agents that are capable of achieving the individual theoretical activation state of the components in the biological pathway. The response surface can thereby be used to evaluate therapeutic combinations for desired or optimal efficacy or synergy. The response surfaces can be created and utilized for various initial or targeted network activation states representing multiple in silico cell lines via digital processing.

Digital processing of computer models of biological pathways or the components thereof can be used to elucidate the dynamic interaction of molecules and biological components in the biological pathways. Biological pathway models can be a useful tool for identifying and describing the route a biological signal must travel to produce a particular biological result or a particular network activation state. The models can be prepared to quantitatively specify the dynamic behavior of the biological pathway in response to a single drug. Computer models can be built, trained, and validated using both in situ generated experimental results and relevant scientific literature.

A biological network-based model can represent the sequence of reactions within a pathway either fully (e.g., mechanistically) or abstractly (statistically). Experimental data can be used in the processes of generating the topology of a particular biological network, which can be initially assembled based on current literature. Experimental data and literature information can be combined in order to assemble a model that accurately reflects a biological network. A network-based model can include a network topology, which includes a number of molecular species, their interactions or reactions, and in some cases parameters and rules. Training of the network-based model with the experimental data can result in a set of parameters that optimally simulate the experimental data when applied to a model. The models can be refined by reconciling the model's output with the experimental data and/or literature information, and can be further extended by including more experimental data or literature information. To be predictive of a state of a biological pathway (e.g., network activation state), the network-based model can include mathematics that describe the signaling network in sufficient detail to match the experimental data and/or literature information, and provide biological insight into the data or information that has been provided. network-based models are versatile; can vary in scope and can be custom built in order to simulate a particular biological pathway or the interactions of components within the biological pathway. Thus, the same network-based model can be used to investigate the effect of a small molecule as well as an antibody depending on the valuation and utilization of various parameters.

Computer models can be prepared using Mathwork's Matlab and the various toolboxes which are part of Matlab to represent interrelationships between the critical biological components of a signaling network and solve for the dynamic behavior. Accordingly, biological pathway information can be described in mathematic equations and inserted into a computer program, such as Matlab, for simulating a network activation state of a desired biological model. The model can be as complex as desired or needed in order to accurately reflect the actual biology and responses to perturbations in the biological network, such as responses to a potential drug. Information relating to systems biology and computational modeling can be found in the following references, which are incorporated herein by specific reference: Kumar, N., et al, (Doug Lauffenburger—SAB member), “Applying computational modeling to drug discovery and development”, Drug Discovery Today 2006; 11:(17-18) 806-811; Schoeberl, B., et al, (Merrimack Publication), “Model-based design approaches in drug discovery: A parallel to traditional engineering approaches”, IBM Journal of Research and Development 2006; 50:(6) 645-651; Sorger, P. (Merrimack founder and SAB member) “A reductionist's systems biology.” Curr Opin Cell Biol 2005; 17:9-11; Nielsen, U B and Schoeberl B (Merrimack paper). “Using computational modeling to drive the development of targeted therapeutics.” IDrugs 2005; 8(10):822-826; Cho, C R, et al. “The application of systems biology to drug discovery.” Curr Opin Chem Biol 2006; 10(4):294-302; Aldridge, B B, et al. (Doug Lauffenburger and Peter Sorger, SAB members) “Physiochemical modeling of cell signaling pathways.” Nature Cell Biol 2006; 8:1195-1203; Mayawala K, et al. “Computational modeling reveals molecular details of epidermal growth factor receptor binding.” BMC Cell Biology 2005; 6:41; Kiyatkin A, et al. “Scaffolding Protein Grb2-associated Binder 1 Sustains Epidermal Growth Factor-induced Mitogenic and Survival Signaling by Multiple Positive Feedback Loops.” J Biol Chem 2006; 281(29):19925; Sible J C and Tyson J J. “Mathematical Modeling as a Tool for Investigating Cell Cycle Control networks.” Methods 2007; 41(2):238-247; Schoeberl B, et al. “Computational modeling of the dynamics of the MAP kinase cascade activated by surface and internalized EGF receptors.” Nature Biotech 2002; 20:370; Hendriks B S, et al. “Computational modeling of ErbB family phosphorylation dynamics in response to transforming growth factor alpha and heregulin indicates spatial compartmentation of phosphatase activity.” IEE Proc-Syst Biol 2006; 153(1):22; and Luan D, et al. “Computationally Derived Points of Fragility of a Human Cascade Are Consistent with Current Therapeutic Strategies.” PLoS Comput Biol 2007; 3(7):e142.

Computational models can be used for predicting the direct and/or indirect effect of a therapeutic agent on a biological pathway or on a component or group of components in a biological pathway. A computational model can be prepared in order to describe a signaling network that includes a therapeutic agent and its target (e.g., receptor), as well as other network components that may or may not interact with the target. Many network components do not directly interact with the therapeutic agent; however, they can have perturbed functionality when the biological network or upstream component directly interacts with the therapeutic agent. In order to prepare a suitable model, a specific network activation state (NAS) can be defined as the response of the biological network or component(s) thereof to the therapeutic agent. A NAS can be either experimentally derived or via model simulation (e.g., in silico).

For example, a set of at least two simulated NASs can be generated by implementing at least two distinct mathematical models of the biological pathway with respect to potential or actual mechanisms of action of at least two distinct therapeutic agents that simulate in silico binding to the target (e.g. ligand-blocking, dimerization-blocking, internalization-inducing, and the like). An experimental NAS can be generated by performing an experiment with cells, and obtaining data from the experiment. The experimental NAS can be compared to the simulated NASs to identify the more accurate of the two simulated NASs. The simulated model that best predicts the effect or NAS of the therapeutic agent on the biological pathway can be chosen based on the closest similarity between the simulated and experimental NAS. Each computational model can be used to identify aspects of the mechanism of action of the therapeutic agent on the biological pathway or portions thereof which are important for compound efficacy (e.g., ligand binding blocking, dimerization-blocking, receptor internalization-inducing, and the like). Such aspects can be useful in determining the mode of administration of the therapeutic agent in order to have an optimum result in the perturbation of the biological pathway in a therapeutically relevant manner. Each computational model can be useful for identifying an optimum mode of administration of a single therapeutic agent in order to perturbate aspects of the mechanism of action and network characteristics (e.g. protein mutations, protein expression levels, phosphorylation status).

Now, such a process can be performed with two or more therapeutic agents, and the data obtained therefrom can be implemented into the preparation of a response surface for the combination therapy with the two or more therapeutic agents. The response surface can then be used to identify optimal mode of administration of the two or more therapeutic agents in the combination therapy.

Additional information regarding the use of mathematical models in digital processing applications can be found in PCT/US2009/054051, which is incorporated herein by specific reference.

In one embodiment, the response surface can be obtained from data generated with a model for the first component and a model for the second component, where the first and second components are in different pathways of a common biological network.

In one embodiment, the present invention includes a computing system that has software components for computation modeling of a biological network. The computing system can be configured to include hardware and software for performing a method of generating and/or using a response surface of a biological network. The method can include any method for preparing a response surface that graphically illustrates the activation level of the downstream component based on two or more components of the biological network that directly or indirectly affect the activation level of the downstream component.

In one embodiment, the method of using a computing system for preparing a response surface can include the following: inputting, into the computing system, digital data (e.g., experimental/simulated data) for a first component and second component with respect to the biological network, said first component and second component have activation states that modulate at least one biological target of the biological network; inputting, into the computing system, digital data (e.g., experimental/simulated data) of the network activation state for the at least one biological target of the biological network; and generating, with the computing system, a response surface from the inputted data that shows the network activation state of the at least one biological target of the biological network in relation to the activation states of the first and second component. Optionally, generating a 2-dimensional dose matrix for activation states of the first component and second component can be performed prior to generating the response surface. The 2-D dose matrix can be employed as described herein.

In one embodiment, the response surface can be prepared with simulated data obtained by the following: inputting, into the computing system, at least one biological network model of the biological network that defines a biological pathway comprised of both known and unknown elements that include biological components and signaling events, and wherein the biological components include at least one biological target for modulation with the first component and second component, where the biological network model output is a network activation state of the biological target; inputting, into the computing system, digital data of the first component and second component into at least one biological network model that defines a plurality of mechanisms of actions that affect the biological response of at least one biological target of the biological pathway with respect to the first component and second component; generating, with the computing system, at least one in silico network activation state by using at least one biological network model, said in silico network activation state providing the biological response of at least one biological target with respect to the first component and second component; and generating and/or providing, with the computing system, output corresponding to at least one in silico network activation state with respect to the first component and second component, said output being configured as a visual or virtual response surface.

In one embodiment, the one or more downstream components are each a known biological target. As such, the known biological target can be included in the data defining at least one of said plurality of mechanisms of actions.

In one embodiment, the present invention includes a computer program product for use in the computing system. The computer program product can include one or more computer-readable storage media having stored computer-executable instructions for implementing the methods of preparing and/or using a response surface.

In one embodiment, the computer generated response surface can be used for identifying an amount of the first therapeutic and second therapeutic to achieve an activation state of at least one downstream component.

In one embodiment, the present invention includes a computing system that has software components for computation modeling of a biological network and being configured for performing the methods of using the response surfaces as described herein.

In one embodiment, the present invention includes a computer program product for use in a computing system. The computer program product can include one or more computer-readable storage media having stored computer-executable instructions for implementing a method of using the response surface.

### C. USE OF RESPONSE SURFACES

Optimal therapeutic combinations may be non-intuitive, and therefore the response surfaces can allow identification of a superior therapeutic combination of FDA approved or potential drugs. The response surfaces can lead to more tractable experimentation and higher probability of success in clinical trials. Also, a poor single therapeutic agent may be rescued by being studied with response surfaces for potential use in a combination therapy with another therapeutic agent.

A response surface of a signaling network can be used to study or estimate species and/or interactions one-by-one so that substantially all possible combinations can be examined quickly and effectively. The best therapeutic combination candidate can be the one which exhibits the greatest change in the network activation state (NAS) relative to the uninhibited system. Also, the method can include identifying, from the response surface, an amount of two or more therapeutic agents to achieve an activation state of the biological target.

When designing a therapeutic combination (e.g., receptor inhibitor/activator combination or bispecific therapeutic) the performance of the individual therapeutic agents can be estimated with a response surface as a combination rather than individually. Many drug combinations have been found by using the standard screening techniques in high throughput processes that screen large numbers of drugs and large numbers of drug combinations. Brute force combinatorial screening of small molecules, Fabs, or ScFvs is either experimentally exhaustive or nearly impossible due to limited or unavailable Fab and ScFv reagents.

While the response surfaces can be utilized to study small molecules or traditional drugs, it can also be applied to antibodies, Fabs, ScFvs, protein drugs, gene drugs, and other therapeutic agents. Accordingly, the present invention provides a method to estimate the effects of drug, Fab, and/or ScFv combinations indirectly using the dual agent-stimulated response surfaces described herein. Also, multi-agent stimulated response surfaces can be used to estimate the effects of potential combinations of therapeutics having more than two agents. The drugs, Fabs, and ScFvs can be tested individually to identify the therapeutic potential, such as by measuring the amount of a phosphorylated target or the like. Experimental measurements of inputs can be used to generate a dose response surface that provides simulated data regarding a particular network activation state of a biological pathway that may include one or more biological networks that are interrelated. The response surface obtained from the inputs can be used to predict a network activation state, such as the amount of phosphorylation of a common downstream target, which is the output of the response surface. The effects of each drug, Fab, and/or ScFv combination can then be translated into shifts along the horizontal and vertical component axes of the response surface. The information obtained from the response surface can then be used to determine a therapeutic combination and amounts of the therapeutics in order to achieve the desired or optimal effect based on output from the response surface.

In addition to therapeutic combinations, the response surface can be used to predict the therapeutic value of bispecific molecules (“bispecifics”). The response surface can be used to identify an optimal targeting strategy for a bispecific therapeutic without requiring a mechanistic model linking upstream and downstream pathway components by measuring response-surfaces in many cell types. This can be accomplished by using the experimental/simulated data for the individual therapeutic agents of the bispecific therapeutic. These therapeutic agents can be combined into a bispecific using a mechanistic model to simulate the effect on the first and second upstream components in many cell types when the avidity parameter is varied. The resulting effects on the first and second components would then be mapped onto the cell type-specific response surfaces to identify a desired or optimal bispecific therapeutic from a larger number of candidates The response surfaces generated from individual data can be used to speed up the bispecific therapeutic (e.g., bispecific with any combination of drug, Fab, and ScFv) selection process by reducing the experimental effort required, saving time and money. The response surface can be used to screen a number of potential bispecific therapeutics so as to identify a desired or optimal bispecific therapeutic from a larger number of candidates. Thus, the response surface can be used to identify superior lead bispecific therapeutics.

In one embodiment, the response surface can be used to identify a combination of therapeutic agents to achieve a activation state of the at least one downstream component. Each therapeutic agent of the combination can be one of an agonist, antagonist, or inhibitor to the biological target (downstream component), or can include coding information for production of a molecule, such as a protein or small molecule, that can interact with the biological target.

In one embodiment, the present invention includes a method of using a response surface to identify a combination of therapeutic agents that achieve an optimal or desired network activation state. Such a method can include obtaining a response surface that has X and Y axes of a graph indicative of activation states of a first component and a second component, respectively, that modulate a downstream component of the biological network. The graphical pattern of the response surface illustrates the activation state of the downstream component with respect to the activation state of the first component and second component. For example, the activation state of the first component, second component, and/or activation state of the downstream component is an amount or change of phosphorylation.

The use of a response surface can include identifying a starting activation state of the downstream component on the response surface. That is, the desired, known or measured activation state of the downstream component is identified so that the starting activation state of the first component and second component can be identified on the axes. Alternatively, the desired, known, or measured activation state of the first component and second component are identified so that the starting activation state of the downstream component can be identified from the response surface.

The use of the response surface can also include identifying a change in activation state of the downstream component on the response surface based on a change in the activation states of the first component and second component. The change in network activation state can be used to identify the change in the first and/or second component. The change in the first and/or second component can then be used to identify a therapeutic drug combination that achieves the change in the activation state of the first and second component, and thereby achieves the change in the network activation state.

Also, the use of the response surface can also include identifying an optimal or desired activation state of the downstream component on the response surface based on the activation states of the first component and second component. The optimal and/or desired network activation state can be used to identify the corresponding level of activation in the first and/or second component that produces the optimal and/or desired network activation state. The corresponding level of activation of the first and/or second component can then be used to identify individual therapeutic drugs that achieve the individual activation levels of the first and second components. The individual therapeutic drugs can be included in a combination therapy that achieves the optimal or desired activation state of the first and second component, and thereby achieves the optimal or desired network activation state.

Accordingly, this can allow for the identification of a first therapeutic agent and a second therapeutic agent that achieves the change in the network activation state or the optimal or desired activation state of the downstream component as indicated on the response surface. For example, the activation state of the first component and second component, which is indicated by the activation state of the downstream component, or vice versa, can be used to identify therapeutic agents that achieve the activation states. Optionally, amounts can also be identified.

In one embodiment, the response surface can be used for screening combination therapies by being correlated with a dose response curve for each of the first therapeutic agent and second therapeutic agent. As such, the dose response curve (e.g., IC50 curve, etc.) can be prepared and then compared to the response surface. Therefore, it is not necessary to perform the entire checkerboard of experiments for the combination of therapeutic agents.

In one embodiment, the response surface can be used by identifying an amount of each of the first therapeutic agent and second therapeutic agent based on identifying the activation states of the first component and second component. The amount of each of the first therapeutic agent and second therapeutic agent can then be estimated that can achieve the optimal or desired activation state of the downstream component.

Also, the response surface can be used by identifying a first activation state of the downstream component on the response surface based on a change in the activation states of the first components, and identifying a second activation state of the downstream component on the response surface based on a change in the activation states of the second component. The first and second network activation states can then be used to identify an optimal or desired network activation state.

In one embodiment, the response surface can be used for identifying a target activation state of the downstream component. The target network activation state can be at an intersection point on the response surface. For example, the intersection point can be identified as follows: identifying a first line from the first activation state that is orthogonal to an axis of the response surface; and identifying a second line from the second activation state that is orthogonal to an axis of the response surface, wherein the intersection of the first line and second line identifies the intersection point, which is the predicted target network activation state.

In one embodiment, the response surface can be used for identifying the amounts of the first component and second component that achieve the target network activation state. The amounts of the first component and second component that achieve the target network activation state can be correlated with amounts of the first therapeutic agent and a second therapeutic agent.

In one embodiment, the response surface can be used for identifying a threshold to be achieved by the change in the activation state of the downstream component as indicated on the response surface. The threshold can be used for optimization, where the threshold can be a specification for criteria for the optimal inhibitor combination. The threshold can identify a value for the activation state of the first or second component, or the target network activation state. For example, the threshold is identified on the response surface. The threshold can be a percentage of inhibition of an activation state of the downstream component. The threshold can also be based on an additive Bliss level or other parameters used in screening molecules for therapeutic agents.

In one embodiment, a synergistic spot can be identified on the response surface. The synergistic spot can mark the optimal performance for an inhibitor combination.

In one embodiment, the response surface can be used for identifying equal-molar dose response curve trajectories for a plurality combination of therapeutic agents. This can be helpful in identifying the optimal combination of therapeutic agents from the plurality. For example, an optimal combination of therapeutic agents can be selected based on at least one of the following: having a steepest gradient on the response surface; passing a threshold; having a comparably better response surface trajectory over a plurality of cell lines; having a comparably better response surface trajectory from a plurality of starting activation states of the downstream component on the response surface; passing a threshold or achieving a desired network activation state while not exceeding a particular concentration of therapeutic agents.

### D. EXAMPLES

Substantially every biological pathway is related to or involved in the processes of another biological pathway. Also, any particular biological component may be involved in more than one distinct biological pathway or involved in a biological pathway at multiple locations. Biological pathways are typically complex systems where multiple components interact to achieve a NAS, which allows for multiple targets to be considered when identifying a particular therapy for a particular disease. While a single target can be identified for a therapeutic agent, the complexity of most biological pathways can allow for multiple targets to be identified for a combination drug therapy.

FIG. 1A is a schematic illustration of a simplified representation of a complex biological network 10. The biological network 10 illustrates a particular pair of signaling pathways (e.g., IGF/IGFR pathway, and the HRG/ErbB3 pathway) that can be desirable for inhibiting simultaneously. These different pathways both activate the same molecules “downstream” in the network: for instance they both activate Akt and Erk. However, this common activation can be very complex and non-intuitive due to feedback and crosstalk between the signaling pathways. As a result, the effect of inhibiting the biological network or individual IGF/IGFR pathway and/or the HRG/ErbB3 pathway can be complex and non-intuitive as well. In order to determine a NAS for the biological network, it could be beneficial to develop and use a computational model to predict which combinations of drug candidates would be most effective in inhibiting multiple signaling pathways simultaneously. However, the development of a single mechanistic model that governs the combination of both pathways from “first principles” is very challenging and may be overly burdensome.

For example, the biological network 10 can include an insulin-like growth factor receptor 12 (IGFR) for insulin-like growth factor 14 (IGF) and ErbB3 receptor 16 (e.g., tyrosine kinase epidermal growth factor receptor) for heregulin 18 (e.g., growth factor). The IGFR 12 is shown to be a receptor for IGF 14 and interaction thereof signals an insulin receptor substrate (IRS) 20 (e.g., signaler protein) to function (e.g., become activated) within the biological network 10 so as to cause biological activation of ERK 22 (e.g., extracellular signal-regulated kinase) and/or AKT 24 (e.g., cellular signaling protein). Additionally, the ErbB3 16 is shown to be a receptor for HRG 18 and interaction thereof signals Gab1 26 (e.g., GRB2-associated binding protein; signaler protein) to function (e.g., become activated) within the biological network 10 so as to cause biological activation of ERK 22 and/or AKT 24.

It can be seen that both IGFR 12 and ErbB3 16 can be targets in regulating the activity of ERK 22 and/or AKT 24 because of considerable cross-talk between the pathways. Accordingly, a mathematical model for the biological network 10 can be prepared to describe a network activation state in response to either an input IGF 14 or to HRG 18. However, it is exceedingly difficult to prepare a mathematical model for the biological network 10 that accurately reflects inputs from both IGF 14 and HRG 18. Since the signaling pathway of each IGF 14 or HRG 18 can impact the NAS (e.g., output of ERK 22 and/or AKT 24), both signaling pathways can be interconnected.

As such, the mathematical models for biological network 10 that accurately reflect inputs from both IGF 14 and HRG 18 can be combined in order to identify a combination therapy based on both IGF 14 and HRG 18. However, integration of the models for both IGF 14 and HRG 18 may not be trivial. Also, it should be noted that the present invention is not limited to the illustrated biological pathway 10, which is shown as an example, and can be applied to any biological pathway and/or biological networks.

The ErbB3 and IGFR pathways connect two signaling cascades which contain complex feedback mechanisms. The result is crosstalk between the different pathways, which form a biological network with interpathway crosstalk.

FIG. 1B is a schematic illustration of a simulated biological pathway 10a, which is essentially a digital processing simulation of the biological pathway of FIG. 1A. The simulated biological pathway 10a is shown to have inputs for IGF 14, IGFR 12, HRG 18 and ErbB3 16, and outputs of ERK 22 and AKT 24. Additionally, the simulated biological pathway 10a is shown to have a model 28 that models the biological pathway 10 in order to identify a combination therapy 30. For example, the model 28 can be configured to distinguish and/or characterize the cross-talk in the biological pathway 10. While such a model 28 maybe possible to construct, such a model will usually require a significant amount of actual experiments in order to prepare a combined model representative of the inputs for IGF 14, IGFR 12, HRG 18 and ErbB3 16, and outputs of ERK 22 and AKT 24. Additionally, the model 28 is not additive of the models for both IGF 14 and HRG 18. That is, the models cannot simply be added together. The model 28 is substantially more complex and difficult to work with compared to the individual models for both IGF 14 and HRG 18. Thus, it can be advantageous to prepare a response surface or virtual response surface in order to have a simulated biological pathway 10a, where the model 28 is substituted by a response surface that includes “smaller” models for both IGF 14 and HRG 18 that allows for an optimum combination therapy to be identified.

The response surface for IGFR 12 and ErbB3 16 can be generated using distinct experimental/simulated data of the protein signaling networks for both IGFR 12 and ErbB3 16, and allow for the development of predictions of responses to the therapeutics. The level of ligand (e.g., HRG or IGF) in the biological network can be used to identify the corresponding activation of the receptors or components (e.g. ErbB3 or IGFR). The level of activated components can then be used as input to the response surface to identify the level of the activated downstream component (e.g. ERK, AKT), where the activation state of the downstream component can be considered the network activation state as output.

The response surface can encompass two or more outputs from single receptor signaling networks at one time so that each individual axis predicts the biological response to only one input, such as an activated component in the biological network. It is the combination of the individual inputs that can be used to generate the suitable output data to create a response surface. The response surface can aid in developing combination therapies that include individual therapeutics that each may be targeted against different portions of a signaling network for a desired therapy. The response surface thereby can be utilized as a predictor of the network activation state of a biological target (“downstream component”) of a signaling network.

FIG. 2A is a graphical representation of a two-dimensional (2D) dose matrix based on the phosphorylation of IGFR (e.g., pIGFR) on the Y-axis and the phosphorylation of ErbB3 (e.g., pErbB3) on the X-axis. In the absence of a fully-developed mechanistic model that predicts the effects of simultaneous inhibition of the ErbB3 and IGFR networks, a “data-driven” approach to predicting the effectiveness of combination therapies can be used. For example, it may be desirable to have a combination drug therapy which simultaneously inhibits the IGF/IGFR network and the HRG/ErbB3 network, as shown in FIGS. 1A-1B. As such, a response surface can be prepared from the data obtained from each model, which describe the outputs of an exemplary system (e.g., the system can be a cancer cell line) to different amounts of simultaneous activation of the two networks. Inputs can be obtained from activation states of each individual network.

In one example, the activation state can be considered the phosphorylation levels of IGFR (e.g., pIGFR) and ErbB3 (e.g., pErbB3) obtained in response to different amounts of IGF and HRG ligand. While the response surface can be created with data relating to IGF and HRG, the response surface can be used to explore the possibility of other active agent combinations. Experimental protocols for generating data on the levels of phosphorylated protein, or levels of outputs such as proliferation, are well known in the art. Outputs can be the activation state which represents the individual activation of a single model or the combined activation of the global network—it integrates the simultaneous addition of inputs from the individual networks. Also, the outputs can be a variety of biochemical or biophysical readouts, such as a phosphorylated protein like Akt (e.g., pAkt), cell proliferation, or the like. A checkerboard dose-matrix can be a two-dimensional description of all possible combinations of different amounts of input states (e.g., if input 1={1,2} and input 2={1,2}, the combinations are {1,1 } {1,2} {2,1} and {2,2}). A checkerboard dose-matrix can be prepared with data from two individual models for input 1 and input 2. The response surface is a graphical representation of the system output response to the conditions in the checkerboard matrix. The checkerboard matrix input states are themselves experimentally or computationally determined activation levels of the first and second component (not just the amount of stimulus).

An alternative to understanding the complexity of the downstream signaling network is to measure the downstream readouts directly. This non-mechanistic approach links receptor activation (e.g., phosphorylation) with a downstream readout creating a non-linear shaped response surface that replaces the complex signaling network. As such, complicated mathematical models of complicated biological networks do not need to be analyzed, simulated, or computed. Instead, the downstream data in response to upstream activation levels can be used to generate a response surface that can provide meaningful information regarding the network activation state that a combination therapy may be designed to achieve. A response surface can be experimentally generated by stimulating a cell with a ligand (e.g., IGF and HRG) in a checkerboard combination, and then measuring the upstream and downstream readouts of the activation states of the downstream component that are obtained by different levels of stimulation with the ligand.

For example, pIGFR and pErbB3 are inputs into the checkerboard dose matrix instead of IGF and HGR. This enables the effects of any therapeutic agents, that modulate/activate the first and second component (IGFR and ErbB3 to pIGFR and pErbB3), to directly shift the position of the network activation state of pAkt on the response surface. If the inputs to the checkerboard dose matrix were IGF and HRG, there would be no way to include the effects of the therapeutic agents as the therapeutic agents do not appreciably affect the amount of IGF and HRG in the system. As such, activation of the components provides better input for obtaining network activation state output.

It can be important to separate ligand-receptor non-linearities from receptor-Akt non-linearities. Reducing or accounting for the complexity (non-linearity) in the system is necessary to predict the biological output (e.g., activation state of the downstream component). By measuring the activity of the receptors (e.g., components of the network) it is possible to separate ligand-receptor non-linearity from receptor-Akt non-linearity, and therefore reduce the complexity of the system. Receptor-Akt non-linearities are essentially the intracellular signaling network which translates the inputs (modulated/activated receptors) into downstream responses, such as the activation state of the downstream component. The non-linearities are represented in the response surface.

The checkerboard dose-matrix can be created by first performing separate serial dilutions of each stimulus (IGF and HRG) and measuring (experimentally or simulated computationally) the activity of the appropriate input component (pIGF1R or pErbB3). Then pair-wise combinations of all stimuli dose levels are performed. This can be done experimentally or computationally. The response surface shape is most likely non-linear, reflecting the non-linearities in the system. The impact of the inhibitors is included by shifting the amount of activation of pIGF1R and pErbB3 appropriately (measured or simulated inhibition); this translates into a shift in the biological output, pAkt.

FIG. 2A schematically represents a checkerboard dose-matrix, which can be used to generate a response surface as shown in FIG. 2B. The 2D checkerboard dose-matrix can be prepared by: studying pIGFR and pErbB3 independently with in vitro studies; obtaining data from the in vitro studies; and plotting the data in a 2D checkerboard. The 2D checkerboard dose-matrix graph illustrates the Akt activation (e.g., phosphorylation pAkt; cell proliferation, or the like) in response to pIGFR or pErbB3, independently.

The result of graphing the data of the network activation state in response to the component activations is a response surface. The response surface can be used to estimate downstream readouts (e.g. activation state of the downstream component) from the levels of component activation (e.g., level of receptor phosphorylation). As shown in FIG. 2B, a response surface is a grayscale contour map that represents the level of the downstream readout; white is zero activation, and black is maximum activation.

The response surface of FIG. 2B is developed by sampling different amounts of phosphorylated pErbB3 and pIGFR, and measuring the overall system response of the output. Different levels of inputs are created by adding different amounts of ligand to the system being studied. For example, it might be reasonable to consider 10 different input states of pErbB3 and pIGFR, resulting in 100 data points on the pAkt response surface. Accordingly, the pIGFR and pErbB3 data provide a response surface indicative of the Akt activation. The response surface implicitly contains receptor non-linearities, such as the effect of other receptors, dimerization, and the like. The pAkt response of the combined ErbB3 and IGFR networks increases with increasing pIGFR and pErbB3; at a given level of either, additional input from the other phosphorylated receptor results in higher amounts of readout.

The shape of the response surface provides insight into the relative strengths of IGF and HRG at mediating the signaling pathways of the biological network in the particular cell line. As such, it may be beneficial to generating a response surface for a number of cell lines in order to gain insight into an optimal combination therapy that is effective across multiple cell lines, which is more likely to be indicative of the internal signaling biologics of a subject.

The response surface shown in FIG. 2B is symmetric around the main diagonal; however, such symmetry may not be observed experimentally. The shape of the response surface may change depending on whether any of the components or downstream components are expressed at a greater level. Also, any variance in the affinity of the different stimuli (ligands) for the respective components (receptors) can cause asymmetry in the response surface. Additionally, any variance in the downstream signaling effects on the downstream component can also introduce asymmetry into the response surface. Moreover, the response surface may show via asymmetry that one of the activated components may saturate the downstream signaling effects and thereby saturate the activation state of the downstream component at a lower dose of activated component. The shape of the response surface can drive the design principles for a combination therapy or a bispecific.

FIG. 2C is a schematic diagram that shows the interrelation of the biological pathway of FIGS. 1A-1B and the response surface of FIG. 2B. This shows that developing the response surface empirically allows the behavior of a combined signaling network to be defined, even in the absence of detailed information about the interactions of proteins between the two networks. Accordingly, the amount of IGF and HRG can be entered into the models, and the response surface provides a prediction of the level of active Erk or Akt. The data is an estimation of protein interactions and enzyme reactions of the biological pathway. Thus, the response surface provides predictive output information based on the measured behavior of the entire network empirically.

As can be seen in FIG. 2C, the Y-axis is representative of the activation state of IGFR (e.g., pIGFR) in response to IGF, and the X-axis is representative of the activation state of ErbB3 (e.g., pErbB3) in response to HRG. The dashed lines that intersect X and Y-axes both intersect on the response surface to show the activation state of Akt (e.g., phosphorylation). By moving along one axis or the other, the activation state of Akt can be changed. Thus, identification of the parameters that affect to pIGFR or pErbB3 can be used to select the conditions for a desired Akt activation state, such as the pAkt activated state. The response surface can then be used in identifying a combination drug therapy because it essentially operates as a lookup table.

The shape of the response surface can be useful in identifying improved optimal combination therapies and bispecific agents. When one component (e.g., receptor) shows a stronger activation/modulation/inhibition of the downstream component in the downstream readout, that component can have more stringent criteria when selecting the combination therapy agents. For example, if pErbB3 is a stronger activator of pAkt than pIGFR, when both ligands are present modulating/activating/inhibiting pIGFR alone may not be effective, or even modulating/activating/inhibiting pIGFR fully when pErbB3 is only partially modulated/activated/inhibited may be of little benefit. For selection of agents for a combination therapy or bispecific the response surface can assist in setting affinity thresholds for candidates to achieve.

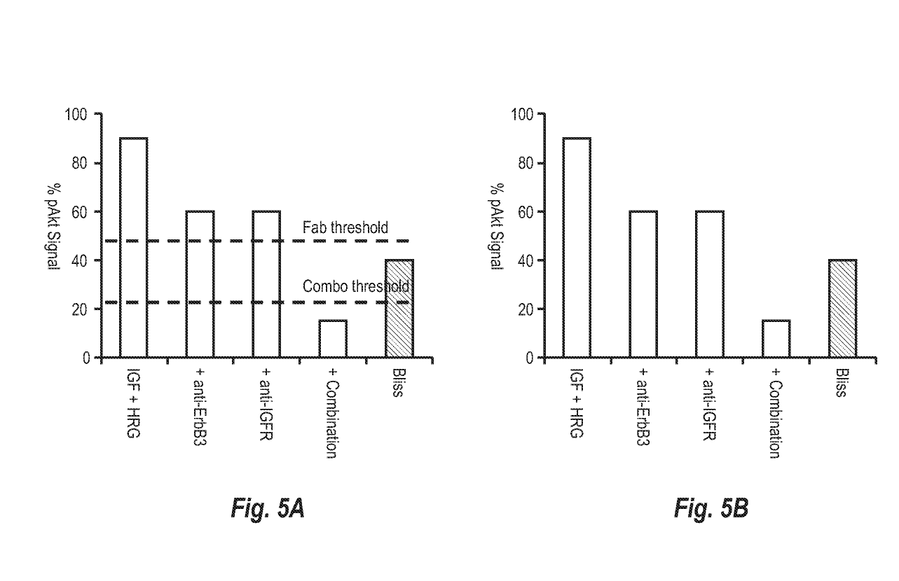

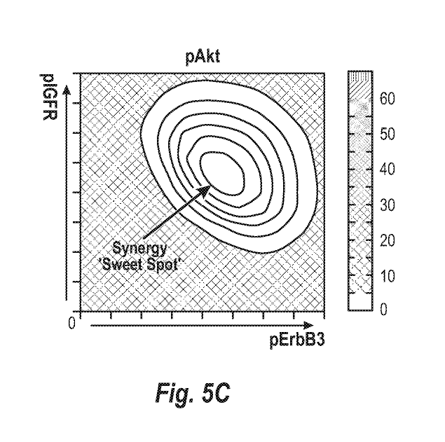

The initial process can include estimating the dose response for each potential therapeutic agent on pIGFR and pErbB3 levels in the presence of HRG or IGF (see FIGS. 3A-3C). This can be done experimentally for each potential therapeutic agent in one cell line. It can also be done computationally with mathematical models by using known characteristics of the potential therapeutic agents, such as Kd, Kon, Koff or the like, and selecting a therapeutic agent and ligand concentration. The dose response curves for each therapeutic agent for a particular component (e.g., IGFR) can be experimentally determined or computationally estimated. Experimental data can be beneficial and can be used to identify whether the therapeutic agent is ligand-blocking, and can take into account the effect of peripheral components of the biological network, such as, for example, ErbB2, ErbB1, IR, or the like. Once the effect of each potential therapeutic agent in isolation is calculated, it is then possible to use the response surface to estimate the effect of every possible combination of anti-ErbB3 and anti-IGFR therapeutic agents (FIG. 4A-4B).

The effect of anti-ErbB3 and anti-IGFR therapeutic agents can be measured or computed separately, and then both effects are used to predict the change in the downstream readout of the activation state of the biological target using the response surface. The predicted downstream readout level of the activation state of the downstream component can be compared to the Bliss independent additive level. Bliss independence is calculated by multiplying the separate activation effects of the anti-ErbB3 and anti-IGFR therapeutic agents. The comparison of the response surface readout and the Bliss independence can be used to identify regions of the response surface that will response synergistically to the combination therapy of the anti-ErbB3 and anti-IGFR therapeutic agents.

The response surfaces can be used to predict the effects of different therapeutics (e.g., inhibitors) on the combined network. As such, the response surfaces can be used to simulate multiple potential therapeutics against both IGFR and ErbB3; the goal is to choose the most effective combination of therapeutics for each network. However, it isn't feasible to directly test all possible combinations of therapeutics (e.g., inhibitors). Thus, the response surface can be used to computationally test the combinations of drugs, which is much more efficient that experimentally testing the different drug combinations.

Also, it should be noted that the response surface is described to be generated with an anti-ErbB3 Fab, anti-ErbB3 ScFvs; however other ErbB3 inhibitors or active agents can be similarly used. Generally, the IC50s of pErbB3 and pIGFR are determined separately. Also, for Fabs and/or ScFvs, quantities may be limited, therefore, Kd, Kon, and/or Koff can be used to approximate pErbB3.

FIGS. 3A-3C show a series of graphs that can be used in preparing a response surface. For example, the effect of each therapeutic agent (e.g., inhibitor) acting alone on its cognate input is measured, as shown in the IC50 curve (i.e., dose response curve) schematically shown in FIG. 3A. For instance, the effect of different levels of anti-ErbB3 on the amount of pErbB3 is measured. This type of assay is well-known in the art.

The inhibition information is then compared (e.g., connected or correlated) to the response surface itself. This correlation can be made by assuming that adding inhibitor is equivalent to reducing the amount of ligand in the system, thus changing the response output. FIGS. 3A-3C demonstrate the process for performing the correlation with inhibition information and the response surface in order to simulate and determine a combination drug therapy.

FIG. 3A shows the step of choosing (e.g., circled data) a level of one ligand (e.g. 10 nM of HRG), and measuring the input (pErbB3) with respect to multiple inhibitor levels. When this step is performed, it can be beneficial to choose an appropriate metric for inhibition of the network (e.g. the level of pErbB3 at 1 nM of inhibitor).

FIG. 3B shows that adding 1 nM anti-ErbB3 inhibitor (e.g., from circled data with arrow to circled data point) reduces the amount of pErbB3 equivalent to reducing the level of HRG from 10 nM to 1 nM in the absence of inhibitor. By reducing the amount of pErbB3, the inhibitor is moving to a different part of the response surface. For example, it can be assumed that the IGFR network is not activated; however, an activated IGFR network can also be used as an assumption (not shown).

FIG. 3C shows that the response surface predicts that reducing the amount of pErbB3 input from 1 to 0.4 (shown in FIG. 3B) will result in output (pAkt) reduction from 0.65 to 0.45. This is the predicted effect of adding 1 nM anti-ErbB3 antibody in the absence of activation of the IGFR network. Also, a step of performing the equivalent experiments can be conducted in order to delineate the effect of anti-IGFR antibodies in inhibiting the IGFR network in the absence of HRG.

In FIG. 3B, the data shows what will be the X axis on FIG. 2B. The same data for pIGFR can be used for the Y axis on FIG. 2B. The checkerboard dose matrix of FIG. 2A shows all of the different concentrations of activated component, and experiments can be performed for the different concentrations in order to measure the downstream output. The downstream output is then combined with the data for the components to prepare the response surface.

For example, refer to the top circled square (data point) in FIG. 3B, and to the top circled square of FIG. 3C. These are corresponding data points, which would refer to a point along the X axis of the response surface where the amount of pErbB3 and pAkt, and then the response surface is built from the experimental data. As such, the checkerboard graph of FIG. 2A shows the experimental data points to be assessed. The response surface is just basically plotting the data obtained from the experimental data points.

After calculating the effect of each individual inhibitor on the response output of its cognate network, the response surface, as shown in FIG. 4A, can be generated and used to predict the effects of combinations of inhibitors (e.g., inhibitor drugs or other drugs) without having to do specific drug combination experiments. The horizontal and vertical axes show how the anti-ErbB3 or anti-IGFR therapeutic agents (e.g., inhibitors) impact the amount of input (pErbB3, pIGFR) induced by each ligand (HRG and IGF). This results in a shift in the amount of pAkt from the starting amount shown in circle 50 to an amount of pAkt shown in circle 52 horizontally from circle 50, or to an amount of pAkt shown in circle 54 vertically from circle 50. The combination can be read off the response surface by applying both the horizontal shift and the vertical shift in amount of pAkt, resulting in the predictive amount of pAkt shown in circle 56. The predictive amount of pAkt shown in circle 56 is vertical from circle 52, horizontal from circle 54, and diagonal from circle 50. The predictive amount of pAkt shown in circle 56 can then be references to the Y-axis to determine the amount of anti-IGFR, and can then be references to the X-axis to determine the amount of anti-ErbB3. The amounts of anti-IGFR and anti-ErbB3 identified on the axes are the amounts for the combination drug therapy of anti-IGFR and anti-ErbB3 to achieve the predictive amount of pAkt. Thus, the response surface can be used to predict the effects of a combination without the combination ever being tested.

Optionally, experiments can be performed with the combination drugs at the identified amounts so as to experimentally validate the assumption that adding inhibitor has the same effect on the input (pErbB3, pIGFR) as reducing the amount of ligand in the system in the absence of inhibitor. Optimally, the validation experiments can show that the amount of pAkt follows the response surface in going up the response surface and back down with no hysteresis or minimal hysteresis.

Accordingly, by taking the pErbB3 level (from HRG and anti-ErbB3 therapeutic agent) and the pIGFR level (from IGF and anti-IFGR therapeutic agent) as inputs, the response surface can be used to predict the downstream readout of the activation state of the downstream component. First, the amount of downstream readout (e.g., activation state) of the downstream component induced by IGF-mediated pIGFR and HRG-mediated pErbB3 is selected from the experimental data on the response surface. In FIG. 4A, this is circle 50. The effect of anti-ErbB3 therapeutic agent on the downstream readout of the activation state of the downstream component is then estimated by reducing the pErbB3 signal according to the measured/computed data of the dose-response curve, which is shown by moving from circle 50 to circle 52. The effect of anti-IGFR therapeutic agent on the downstream readout of the activation state of the downstream component is then estimated by reducing the pIGFR signal according to the measured/computed data of the dose-response curve, which is shown by moving from circle 50 to circle 54. The effect of the combination of the anti-ErbB3 and anti-IGFR therapeutic agents is then predicted by decreasing both pErbB3 and PIGFR, which is shown by moving from circle 50 to circle 56. Thus, circle 56 shows a theoretical optimal combination therapy of anti-ErbB3 and anti-IGFR therapeutic agents in achieving the activation state of the downstream component, pAkt.

The assumption with this method of using a response is that the different therapeutic agents act by decreasing the amount of activated receptor (i.e., pErbB3 from low HRG is equivalent to pErbB3 from high HRG and anti-ErbB3 therapeutic agent). This assumption can be tested experimentally. Another assumption is that the anti-ErbB3 therapeutic agent has substantially no effect on IGFR, and anti-IGFR therapeutic agent has substantially no effect on ErbB3.

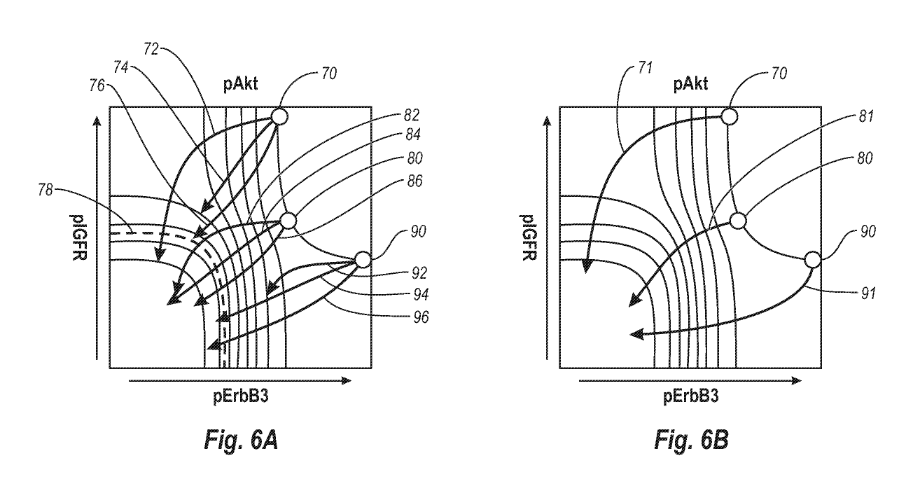

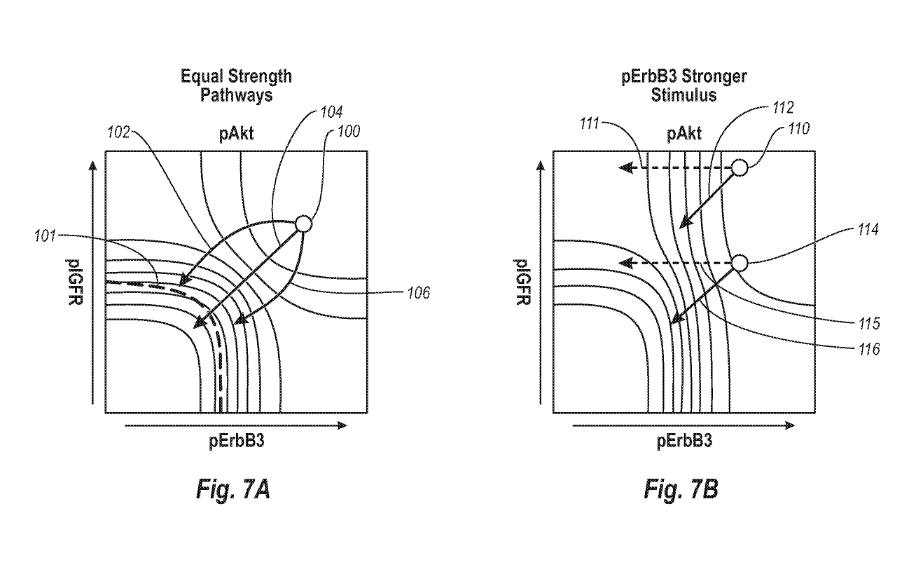

The steepness of the response surface in different regions can determine whether the combination of the therapeutic agents act additively, synergistically, or antagonistically. As such, a Bliss independence analysis as shown in FIGS. 5A-5B can be used to identify whether the therapeutic agents act additively, synergistically, or antagonistically.

The presence of synergy can be determined by the shape of the response surface, and therefore is more indicative of the properties of ErbB3 and IGFR pathways than the actual therapeutic agents. Nonetheless, the existence of synergistic modulation/activation/inhibition may relax constraints that are placed on the individual therapeutic agents of a combination therapy. For example, synergistic inhibition may make a low affinity anti-IGFR therapeutic agent in combination with a high affinity anti-ErbB3 therapeutic agent almost as effective as a high affinity anti-IGFR therapeutic agent in combination with a high affinity anti-ErbB3 therapeutic agent.

Accordingly, the response surface methodology for identifying combination drug therapies is more experimentally efficient than experimentally measuring the effect of combining every possible therapeutic agent combination. For example, 20 anti-ErbB3 therapeutic agents multiplied by 20 anti-IGFR therapeutic agents would be 400 pairwise combinations. However, using the response surface methodology requires significantly less experimental data. In this specific example, only 40 (e.g., 20+20=40) experiments with the various single therapeutic agents would be required as inputs to the response surface methodology for selecting combination therapies. Other examples may vary.

Additionally, it can be beneficial to have an indication of the behavior of the system to increasing, yet equimolar, amounts of inhibitors. FIG. 4B illustrates three different hypothetical inhibitor equimolar dose responses from an initial hypothetical amount of pAkt shown as circle 60: response A is shown by arrow 62, response B is shown by arrow 64, and response C is shown by arrow 66. It is expected that different combinations will have different potency for each of the inputs (pErbB3, pIGFR) and this will lead to different trajectories of inhibition down the response surface.

FIG. 5A is a graphical representation of data that allows for the use of predictions of the combination of inhibitor drugs in order to rank inhibitor combinations. For example, inhibitor drugs can be prepared or developed (i.e. converted from Fab to antibody, or vice versa), and a set of inhibitor drugs, such as those identified by the response surface to have desirable or optimal quantities are further investigated. The graph of FIG. 5A shows percentage inhibition of the target as read off the response surface. A dose of each of the inhibitors separately reduces the pAkt signal to 60%. A hypothetical inhibition threshold can be marked at 50% indicating a desirable inhibition level the inhibitors can achieve individually to be considered as candidates for the next stage of development as drug candidates. Neither the anti-ErbB3 nor the anti-IGFR inhibitors pass the 50% threshold. However, any relevant or possible threshold can be used in the analysis. It should be noted that similar graphs can be prepared for therapeutic agents that are activators or agonists instead of inhibitors.

A hypothetical combination threshold can be set at 25%. The threshold can be chosen using Bliss independence criteria for additivity (e.g., multiply effects of inhibitor in this case the Fab threshold for each inhibitor, 50%×50%=25%). Bliss independence is shown in FIG. 5B. In this way, the drug combinations can be ranked and more combinations may be considered viable candidates. This ranking can have the effect of increasing the number of candidate inhibitors (e.g., inhibitor combinations) moved to the next stage; however, not all combinations need to be tested at the next stage, only those which passed the threshold criteria. The combination of anti-ErbB3 and anti-IGFR reduces pAkt to about 15% as shown, which is well below the combination threshold of 25%.

FIG. 5B shows that the inhibitor combination can be synergistic as compared to the additive Bliss level (unexpectedly better). FIG. 5C shows the synergistic spot of a response surface. This may suggest that the two pathways interact is some unexpected manner. This synergy may also mean that the requirements for an individual inhibitor to be successful may be much different than for a combination to be successful. Also, as no inhibitor combination experiments are performed, the predicted synergy is based on the shape of the response surface, such as from data from ligand combination experiments. Synergy is due to shape of response surface, not inhibitors, especially if only Kd values of inhibitors are used in the calculations.

The response of Akt to either pIGFR or pErbB3 can be used to predictor and is compared to output of models of the individual pathways of IGFR or ErbB3. Synergy is the deviation positively or negatively from what you would predict using a model. For example, create a response surface that is based just on the activity, and create a separate response surface from experimental data. The additive effects of the output are subtracted from the actual data, and when the data seems to be added to the effects it is synergistic, according to that definition. FIG. 5C shows that a high concentration or high activation of pErbB3 is indicative of a synergistic increase in pAkt. Therefore, the combination therapy is more effective that the additive effects.

FIGS. 5A and 5B show the Bliss independence value. In one embodiment of the present invention, a goal is to identify combinations of therapeutic agents (inhibitors) that are more effective than the Bliss independence so that the % pAkt signal is of the combination is less then the Bliss value.

Synergy is not necessary but might indicate an unexpected mechanism (i.e. block ErbB3-IGFR heterodimers). Also, synergy may obtain maximum efficacy with minimum dose. Also, synergy may identify inhibitor combinations that are effective when the individual inhibitors are not sufficient for further study as a drug candidate. For example, the synergy can relax Kd constraints. For example, a weak anti-IGFR and strong anti-ErbB3 inhibitor combination can be almost as good as strong anti-IGFR+strong anti-ErbB3.

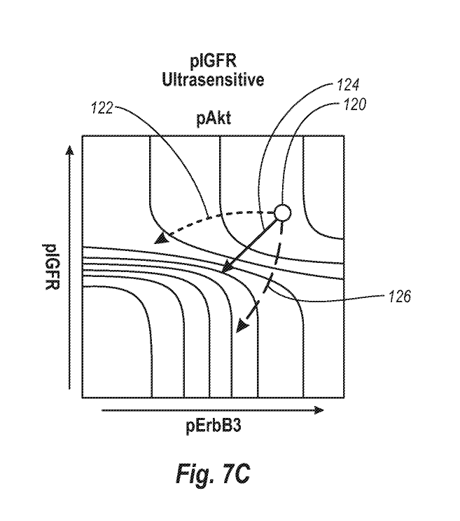

FIGS. 6A-6B are graphical illustrations that describe how to use equimolar ratios of increasing inhibitor concentrations. As shown, equal-molar dose response surface trajectories are calculated, where three starting activation states are shown. The response surface trajectories can be calculated for every potential inhibitor combination to arrive at the amounts of pAkt. The response surface trajectories for the inhibitor combinations are ranked by ability to inhibit pAkt to below a selected threshold. The response surface trajectories are compared to the gradient of the response surface, where the most efficient, effective direction is down the steepest gradient of the response surface to inhibit pAkt. The effects of the combination dose response surfaces are indicated by the different arrows from the different amounts of pAkt.

As shown in FIG. 6A, it is shown how three hypothetical pAkt starting points compare: pAkt A 70, pAkt B 80, and pAkt C 90. The dashed criteria line 78 indicates the 25% threshold which the inhibitors may achieve in accordance to given constraints on the amount of inhibitors used (e.g., a maximum concentration, etc.). For example with respect to the starting point of pAkt A 70, arrow 72 is shown to be capable of reducing the amount of pAkt A 70 below the threshold criteria line 78; however, arrow 74 and arrow 76 do not cross the threshold line 78. As such, arrow 72 illustrates a preferred drug combination of inhibitors. Depending on the starting point of pAkt, such as pAkt A 70, pAkt B 80, and pAkt C 90, inhibitor combinations may perform differently depending on the response surface. With respect to the starting point of pAkt A 80, arrow 82 is shown to be capable of reducing the amount of pAkt A 80 below the threshold criteria line 78, as are arrow 84 and arrow 86. When more than one arrow passes the criteria line 78, other factors can be used to determine the best or optimal inhibitor combination. For starting point pAkt 80, arrow 84 appears to provide the best inhibitor combination. With respect to the starting point of pAkt A 90, arrow 92 is shown to be not capable of reducing the amount of pAkt A 90 below the threshold criteria line 78; arrow 94 barely reaches the threshold, while arrow 96 passes the threshold criteria line 78. Accordingly, arrow 96 appears to provide the better inhibitor combination.

FIG. 6B shows the theoretical best path of inhibitor combination given different starting points (pAkt A 70, pAkt B 80, and pAkt C 90). The best path is defined as the steepest gradient down the response surface that is perpendicular to curvature of constant signal level. The steepest gradient indicates the most effective direction to inhibit pAkt, and changes depending on the amount of pAkt (hence the gradient is curved). This could be used to select or design the optimal inhibitor (most inhibition with least dose). As examples: for the pAkt A 70 starting point, arrow 71 is the steepest and is closest to arrow 72; for the pAkt B 80 starting point, arrow 81 is the steepest and closest to arrow 84, but is also close to arrow 82; and for the pAkt C 90 starting point, arrow 91 is the steepest and closest to arrow 96. Therefore, it may be important to perform this analysis at multiple starting points, and look for the inhibitor combination which does the best overall. For example, all inhibitors reduce pAkt to below threshold from the pAkt B 80 starting point, where the steepest path analysis can show that arrow 84 is likely to be the optimal inhibitor combination.

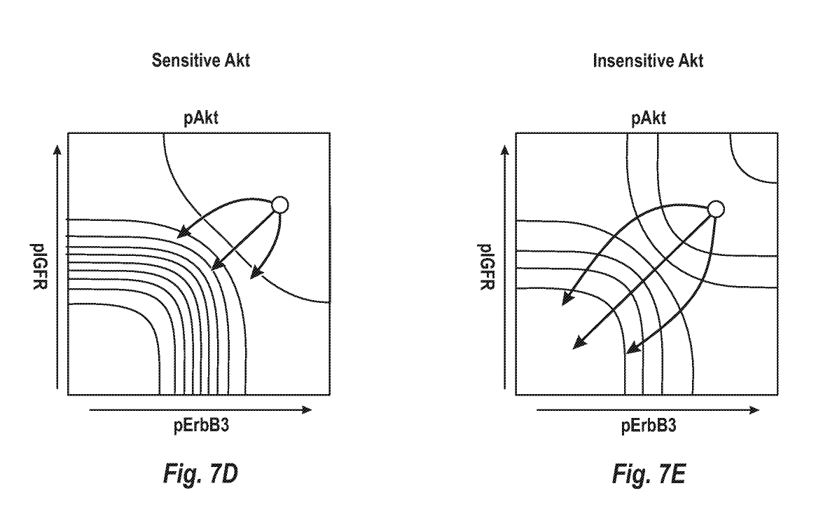

FIGS. 7A-7F are graphical illustrations of 5 different shapes of response surfaces that may be prepared. FIGS. 7A and 7B are the same response surface for cell type 1, which is a symmetric response surface where it is equally important to inhibit pIGFR as pErbB3. The symmetric response surface shows equal strength pathways. In FIG. 7A, a hypothetical pAkt starting point 100 is analyzed for different inhibitor combinations. The dashed criteria line 101 indicates a 25% threshold. The arrow 104 is shown to be capable of reducing the amount of pAkt A 70 below the threshold criteria line 101; however, arrow 102 and arrow 106 do not cross the line. As such, arrow 104 illustrates a preferred drug combination of inhibitors by being the steepest gradient line and crossing the threshold criteria line 101.

In contrast, the cell type 2 response surface of FIG. 7B is asymmetric; pErbB3 more strongly inhibits formation of pAkt at lower doses. This shows that cell type 2 has a stronger stimulus for pErbB3. Assuming a tradeoff between the ability of a combination to inhibit pErbB3 vs. pIGFR, then combinations that inhibit with pErbB3 more than pIGFR would be more effective. For two hypothetical pAkt starting points 110 and 114, the dashed lines 111 and 115 are more effective than the solid lines 112 and 116 because the dashed lines 111 and 115 traverse steeper portions of the response surface, comparatively. From the response surface and drug combinations, cell type 2 may have over expression of ErbB3.

FIG. 7C shows cell type 3, where pAkt increases/decreases in the vertical direction more steeply than in the horizontal direction. This may be pIGFR ultrasensitive, and may arise from IRS1 over expression. As shown for hypothetical pAkt starting point 120, the inhibitor combinations that inhibit pIGFR more strongly will work better as shown by arrow 126 (large dashed line) over arrow 122 (small dashed line) or arrow 124 (solid line).

FIG. 7D shows cell type 4, where pIGFR can almost completely activate pAkt (vertical axis) as can pErbB3 (horizontal axis). This may be sensitive Akt or PI3K overstressing. In FIG. 7D, the combinations are less effective. FIG. 7E shows the opposite scenario of FIG. 7D in cell type 5. This may be insensitive Akt or phosphotase over expression. Thus, the number of combinations that pass the threshold can be dependent on the shape of the response surface, in particular, how strongly each of the pathways can separately activate pAkt.

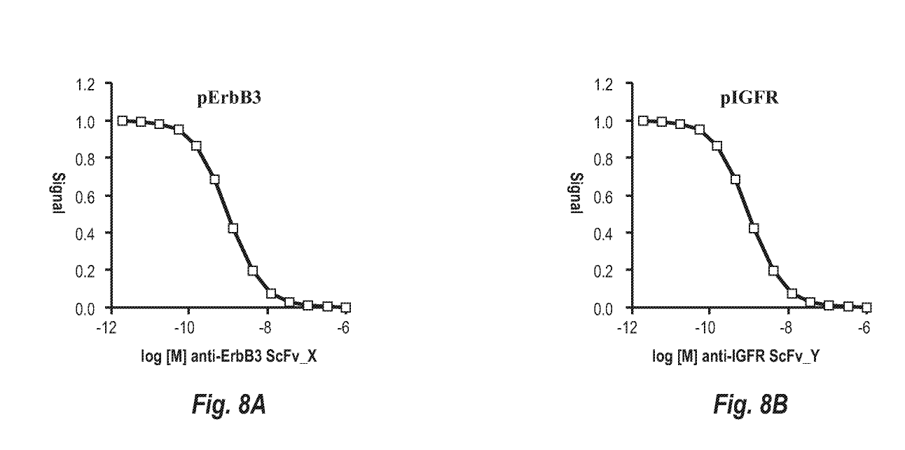

Additionally, the response surfaces can be used for ScFv combination therapies. Anti-ErbB3 Fabs and ScFvs only bind ErbB3, and thus should only inhibit pAkt induced by pErbB3. Also, anti-IGFR Fabs and ScFvs can be used to inhibit pAkt by pIGFR. As such, simple models can be prepared as shown in Equation 1 and Equation 2. Equation 1, ScFv_X+ErbB3 [symbol] ScFv_X:ErbB3 (k1′, kd1′), which generates the graph of FIG. 8A for pErbB3. Equation 2, ScFv_Y+IGFR [symbol] ScFv_Y:IGFR (k2′,kd2′), which generates the graph of FIG. 8B for pIGFR The inputs can include: Kd, koff, kon, and IC50/EC50 for each ScFv and ligand. The same process described herein can be applied to generate a response surface so that a desirable or optimal ScFv combination can be identified.

### II. Bispecifics

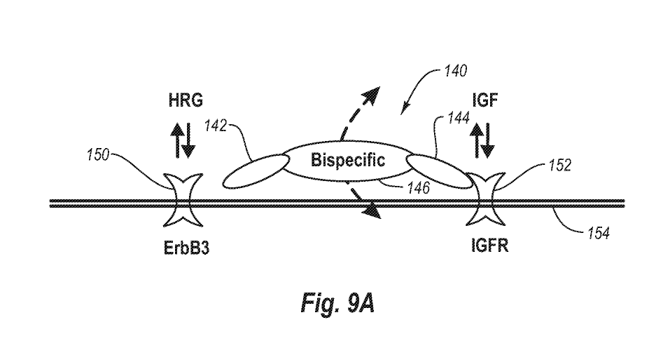

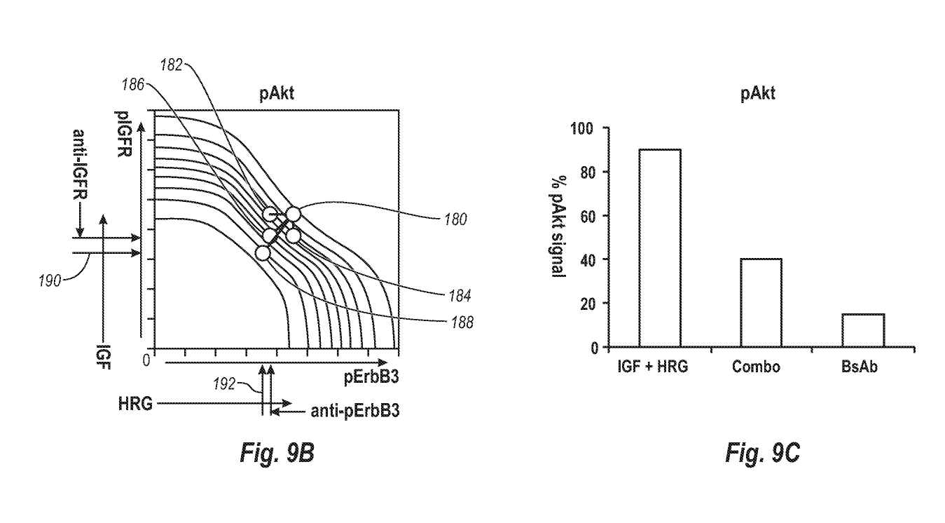

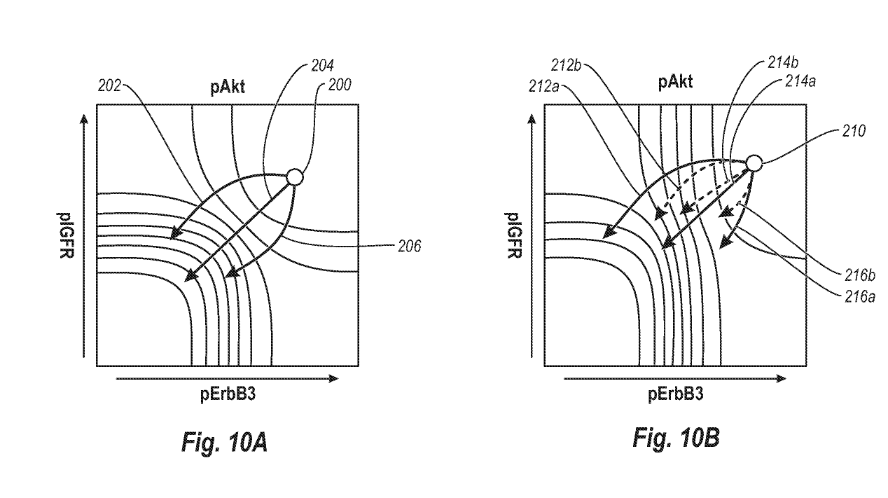

In addition to drug combinations, the response surfaces can be used to assess bispecific molecules. Bispecific molecules generally include a first antibody coupled to a second antibody through a linker. Also, the bispecifics can use Fabs and ScFvs as well as small molecules that are physically linked together. Bispecifics include two antibody components (e.g., Fabs and ScFvs) that are tethered together so as to be capable of binding with two different antigens. FIG. 9A discussed below provides an example of a bispecific having two antibody components (e.g., BsAb).

In simulating potential bispecifics, the response surfaces can be used substantially as described herein with the drug combination being both active molecules of the inhibitor. Also, small and non-complex models can be used to simulate ligand-receptor non-linearity as well as the effect of avidity on bispecific binding. The models can be trained with ScFv data, which can then be used to predict all possible bispecifics with respect to a particular target, network, or pathway.

In the present invention, any combination of therapeutic agents or types of therapeutic agents can be used in bispecific molecules. Screening bispecifics was similarly as difficult as combination drug therapies because of the combining of two or more agents. However, bispecifics have an additional complexity because the bispecific has to be actually made, which is time-consuming and then there is the avidity effect which is difficult to estimate. In certain embodiments of the inventive process, bispecific molecules are not designed and made until the early screening efforts are complete, and the best individual inhibitors are chosen based on the predictions obtained using response surface methodology. Analogously to the problems addressed by using response surface methodologies to optimize inhibitor combinations, this overcomes some of the difficulties encountered when attempting to screen bispecific molecules rather than the individual molecules themselves. Virtual testing of drug combinations can include the use of a response surface generated by stimulating the cellular or biochemical pathways impacted by each drug in the combination using actual data obtained from inhibition experiments with each inhibitor separately. Virtual testing of bispecific molecules can use the same data, but in addition can use a simple mechanistic model to improve the estimation. This is because bispecific molecules are able to bind to two targets at the same time.

By combining the response surface with a small mechanistic model (e.g., mathematical model based on biologics) the effectiveness of a combination of therapeutic agents on a bispecific can be substantially increased. For example, the therapeutic agents can each be an inhibitor, such as an scFv specific to ErbB3 or IGFR, which has been converted to a monovalent or bivalent IgG antibody. A bispecific (e.g., bispecific antibody) can become restricted to the plasma membrane surface when one of the therapeutic agents binds with a target receptor (see FIG. 9A). This restricts the volume where the second therapeutic agent of the bispecific can diffuse due to being localized on the membrane surface, which enhances the affinity of the second therapeutic agent, this effect of enhanced affinity due to proximity is referred to as avidity, and thus proximity effects at cellular targets can result in increasing avidity of a bispecific. Either therapeutic agent of a bispecific can benefit from the increased avidity thus achieved.

In one embodiment of a bispecific molecule 140, as shown in FIG. 9A, one arm is the anti-ErbB3 inhibitor 142 and the other arm is the anti-IGFR inhibitor 144. The anti-ErbB3 inhibitor 142 and anti-IGFR inhibitor 144 are coupled by a linking region 146. In general, the binding occurs in stages, first the bispecific 140 binds to either ErbB3 150 or IGFR 152, the bispecific is now close to the cell surface 154. The closeness of the bispecific 140 to the cell surface 154 enhances the binding rate of the second arm (e.g., other inhibitor) resulting in both ErbB3 150 and IGFR 152 being bound simultaneously. This binding enhancement is called avidity and can be mathematically represented as a multiplicative factor, χ, X, or chi, in the binding reaction due to retention at the cell surface 154 or plasma membrane. The bispecific can be modeled by including the avidity factor. For example, the bispecific mechanistic model can include the four equations shown as Equations 3-6: Equation 3, BsAb+ErbB3 [symbol] BsAb:ErbB3 (k1′,kd1′); Equation 4, BsAb+IGFR [symbol] IGFR:BsAb (k2′,kd2′); Equation 5, IGFR:BsAb+ErbB3 H ErbB3:BsAb:IGFR (χk1′,kd1′); and Equation 6, BsAb:ErbB3+IGFR [symbol] IGFR:BsAb:ErbB3 (χk2′,kd2′). Also, the avidity factor can be different for the first and second therapeutic agents.

By using the equations above, a bispecific can be simulated, and the amount of pErbB3 and pIGFR predicted. The predicted pErbB3 and pIGFR levels can be inputted to the response surface (FIG. 9B), and the amount of inhibition can be calculated from comparison to a “no inhibitor” event with both ligands present (FIG. 9C.)

FIG. 9B illustrates a response surface for the bispecific 140 of FIG. 9A, and shows the effects of a combination or a bispecific on downstream signal that is predicted using the response surface. The horizontal and vertical axes show how the anti-ErbB3 inhibitor 142 and anti-IGFR inhibitor 144 impact the amount of input (pErbB3, pIGFR) induced by each ligand. As such, the model is trained on dose-response curves of individual inhibitors with avidity off (e.g., X=0). When X=0, this represents the straight combination of two separate inhibitors (e.g., two molecules) and the parameters of those equations could be fit using single inhibitor data, as described above in connection with FIG. 4A. This results in a shift in the amount of pAkt from the starting amount shown in circle 180 to an amount of pAkt shown in circle 182 horizontally from circle 180, or to an amount of pAkt shown in circle 184 vertically from circle 180. The combination can be read off the response surface by applying both the horizontal shift and the vertical shift in amount of pAkt, resulting in the predictive amount of pAkt shown in circle 186. The predictive amount of pAkt shown in circle 186 is vertical from circle 182, horizontal from circle 184, and diagonal from circle 180.

Then, with avidity on, the model is used to predict lower pErbB3 and pIGFR, and thereby less Akt. Accordingly, the factor X can be increased to determine the effect of the bispecific molecule on pErbB3 and pIGFR. Due to avidity, the virtual bispecific molecule 140 inhibits pErbB3 and pIGFR to a greater extent than the combination as predicted by the simple mechanistic model. This is shown by the predictive amount of pAkt being shown by circle 188, which is closure to any threshold compared to circle 186. By using the response surface this translates into a further reduction in pAkt shown at circle 188, with the amount of anti-IGFR inhibitor being shown on the Y-axis at arrow 190 and the amount of anti-ErbB3 inhibitor being shown on the X-axis at arrow 192.

As before, a virtual bispecific threshold could be used instead of a Fab or combination threshold to select the best bispecific molecules to design (see FIG. 5A). This includes comparing the pAkt obtained from the simulated bispecific to a threshold and/or compared to the gradient of the response surface. When preparing a bar graph as shown in FIG. 9C, it can be seen that the bispecific (e.g., BsAB, bispecific antibodies) reduces the pAkt signal, and thereby reduces pAkt more than the inhibitor combination or IGF and HRG. FIG. 9C illustrates the percentage of inhibition predicted by the response surface.

A number of bispecific antibodies with different targeting arms (e.g., therapeutic agents) can be tested in silico to find an optimal or improved bispecific. By setting the avidity factors to zero, the bispecific could be directly compared with an inhibitor combination of the therapeutics. It is expected that the avidity resulting from a bispecific antibody can reduce the amount of phosphorylated receptors (e.g., activated components of the biological network) more effectively (e.g., greater shift in FIG. 9B), the thereby can decrease the downstream signaling more than the inhibitor combination (FIG. 9C).

The small mechanistic model combined with the downstream signaling response surface can be used to predict the optimal properties of a bispecific. Such prediction capability allows bispecifics to be virtually studied before being actually prepared. A sufficiently detailed small mechanistic model can be able to distinguish different inhibitor mechanisms of action, and rank the effectiveness of every possible bispecific having combinations of therapeutic agents. This can be used to set limits for key inhibitor properties (e.g., ko, koff, etc.) or to determine under which situations a particular class of bispecific is optimal. For example, an internalizing bispecific may require simultaneous binding, and therefore kinetic off rates may be more important to optimize than kinetic on rates. Another approach can include simulating each bispecific in a number of cell lines with different receptor profiles to identify bispecific characteristics that are improved or optimal in selective regimes (e.g., hi-lo targeting principle. Additionally, bispecifics that perform similarly to their equimolar individual therapeutic agent combinations can be important to identify using the model/response surface because this can indicate potential inhibitor and cell profile characteristics for which avidity is or is not important (e.g., two high affinity binding arms).

Also, the gradient of the response surface is determined from the shape of the response surface, which in itself indicates which upstream component is the stronger activator of downstream readout. This information can be used to determine which upstream readout will be most difficult to inhibit and therefore guides the inhibitor design characteristics, in particular the optimal ratio of the dissociation constant (e.g., Kd or Koff) of each binding arm.

### A. Stratification

The approach to finding an optimal bispecific by using a response surface and a small mechanistic model can be useful in estimating or identifying the best set of therapeutic agents for a bispecific. However, the identification of cell lines, xenograft models, patient tumors, or the like that response to a bispecific can require understanding the complex dynamics of the signaling cascades of various pathways of a biological network that are summarized by the response surface. A fully mechanistic model can be used to extrapolate beyond the observations made using the response surface to new situations.

The output from small model and response surface can be used in the development of a merged two pathway mechanistic model (FIG. 1A) that can be used as part of the response indicator (FIG. 1B). The multi-ligand (e.g., dual-ligand) stimulation experiments, as described herein to build a response surface, can be used to provide insight into how the multiple pathways (e.g., two pathways) can integrate information, as well as inhibition studies performed with the combination of inhibitors and also the bispecifics. The data can restrict the topology of the pathway integration in the mechanistic model. However, the experiments can involve only one time point and more dynamic information can be used to further restrict and/or train the merged model. Stimulation time courses with greater than 5 time points covering short, transient, and long-term signaling can be used. These experiments can be performed at multiple doses with single and dual therapeutic agents. Studies using inhibitors in combination, and as a bispecific, can elucidate signal integration and redundancy within the downstream signaling cascade. This allows for inhibition based experiments to be performed before a final bispecific is produced.

An entire panel of cell lines can be simulated using the merged model. Simulations can include time courses and dose-responses of the effect of single and dual ligands. The cell lines can be profiled for biological network component levels, and also autocrine ligand levels. Predicted sensitive and insensitive cell lines can then be tested in vitro and in vivo, or in xenograft models. Responses in xenografts and other mechanisms of inhibitor studies can be used to build a response prediction scheme that uses statistical methods as well as model simulation to predict cell line, xenograft, and ultimately patient response to the bispecific (FIG. 1B).

Response surfaces can be valuable for identifying optimal drug combinations or bispecifics having essentially zero avidity. However, when there is avidity from the bispecific, it can be useful to use a small model. The small mathematical model can be build, tested, and refined to recreate the response surface at zero avidity.

When two therapeutic agents are combined into a bispecific, the agents should bind their respective receptors more effectively. The small model can then recalculate the activation state of the downstream component. For example, in FIG. 9B, arrows 192 and 190 are closer to the anti-IGFR and anti-ErbB3 arrows because the bispecific avidity binding instead of the anti-IGFR and anti-ErbB3 therapeutics being separate. The difference between circles 186 and 188 is due to the arrows 190 and 192 caused by avidity. The small mathematical model is applied to identify the shifts of arrows 190 and 192 to obtain circle 188.

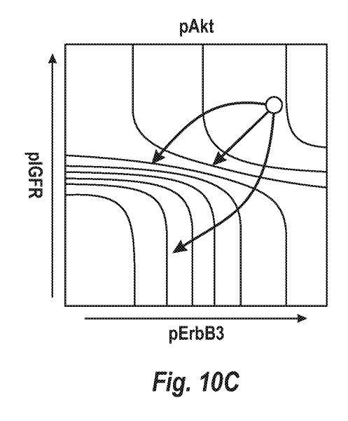

FIGS. 10A-10C are illustrations of hypothetical response surfaces for three different cell lines that can be studied to identify a bispecific with desired or optimal characteristics. FIG. 10A shows three different bispecific surface curve trajectories (202, 204, and 206) for a starting pAkt 200 that are produced by the three different bispecific molecules. As shown, the bispecific surface curve trajectory 204 is likely to yield the desired or optimal characteristics to reduce pAkt because the arrow extends further and appears to follow the steepest gradient of the response surface.

FIG. 10B shows an avidity analysis on bispecifics in another cell line. As shown, the amount of avidity is not constant, and therefore varying the avidity factor, X, can show the importance of the assumed avidity on bispecific molecule performance. For example, for starting pAkt 210, the change in avidity shows the following: for the bispecific with arrow 212a with zero avidity, the dashed arrow 212b shows some avidity; for the bispecific with arrow 214a at zero avidity, the dashed arrow 214b shows some avidity; and for the bispecific with arrow 216a at zero avidity, the dashed arrow 216b shows some avidity. The difference in trajectory from the solid arrows to the dashed arrows shows that dependence on avidity. The dashed arrows with the most change from the solid arrows shows more dependence of avidity.

A concept is that avidity can be different for different molecules, and it is hard to know in advance what the level of avidity is. Therefore, in selecting an optimal bispecific, it can be useful to explore how differences in avidity for any one bispecific shifts the optimal therapeutic combination (e.g., in a bispecific) on the response surface. The graphs show is that in the absence of information on how a given bispecific would behave, the use different avidity assumptions can be used in order to choose the bispecific with the best average predicted performance. Also, specifically with respect to the plot, it shows that dashed lines have lower avidity than solid lines. In FIG. 10B, the performance of bispecific 216 does not depend on avidity, whereas both bispecifics 212 and 214 improve with greater avidity.

FIG. 10C shows an example of three different inhibitors which have different binding properties (top arrow binds best to ErbB3, middle arrow binds equally to both ErbB3 and IGF1R, bottom arrow binds best to IGF1R). The bottom arrow represents an inhibitor with good antagonism of pIGF1R, as result this molecule is the strongest inhibitor of pAkt on the response surface due to the fact that the slope of pAkt to pIGF1R is very steep on this response surface. Therefore, the better IGF1R antagonist is the best of the three inhibitors for this response surface.

In selecting a bispecific with desired, optimal, or improved properties, it can be important to rank potential bispecifics (e.g., BsAbs) with respect to other bispecifics. The ranking between different bispecifics can be done with or without also being ranked compared to drug combinations, ScFv combinations, or Fab combinations.

The selection/design of a bispecific can be influenced by avidity. As such, the selection process can include determining when avidity may be important for inhibition. In some instances it can be desirable to have a bispecific that is more dependent on avidity than other bispecifics. In some instances, it can be beneficial to have a bispecific that can perform well without avidity, such as instances where not much avidity is observed. Thus, the identification of avidity or varied avidity for a bispecific can influence selection of a bispecific.

Also, the robustness of a bispecific can influence the selection/design. In some instances, it can be important for the bispecific to be effective across multiple cell types. Efficacy across multiple cell types is an important indicator for efficacy of the molecule with respect to multiple types of cancer. Therefore, a broad efficacy profile is generally desired. However, there are instances where the ability to have efficacy across multiple cell types may not be important; for example, if the inhibitor is to be used in a restricted indication, where the bispecific target profile is known to be fairly uniform in the patient population.

For example, a bispecific inhibitor can be modeled by first describing the binding of the individual arms (equations 1 and 2 with corresponding parameters: Eq 1: BsAb+ErbB3 [symbol] BsAb:ErbB3 with parameters (kf1,kr1); and Eq 2: BsAb+IGFR [symbol] IGFR:BsAb with parameters (kf2,kr2)). This would be sufficient to also describe a combination. To fully describe a bispecific two additional equations are needed (equations 3 and 4: Eq 3: IGFR:BsAb+ErbB3 [symbol] ErbB3:BsAb:IGFR with parameters (Xkf1,kr1); and Eq 4: BsAb:ErbB3+IGFR [symbol] IGFR:BsAb:ErbB3 with parameters (Xkf2,kr2)) which outline how the bispecific is bind to a second target while remaining bound to the first target. Importantly, an additional parameter, X, is used to describe the avid binding of the second target, primarily due to restriction of the molecule to the cell surface by the fact that the molecule is bound to the first target (volume reduction).

### III. Digital Processing

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

A “computer network” is defined as one or more data links that enable the transport of electronic data between computer systems and/or modules and/or other electronic devices. When information is transferred or provided over a computer network or another communications connection (either hardwired, wireless, or a combination of hardwired or wireless) to a computer, the computer properly views the connection as a transmission medium. Transmission media can include a computer network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a computer network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a computer network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. All references recited herein are incorporated herein by specific reference in their entirety.

What is claimed is:

1. A method for selecting a combination of a number of candidate therapeutic agents, said number constituting a plurality, which selected combination is capable of mediating, in a cell, a change of an activation state of a first upstream component of a biological network within the cell and a change of an activation state of at least a second upstream component of the biological network, the changed activation states of the upstream components that said selected combinations are capable of mediating in turn altering an activation state of at least one downstream component of the biological network, which altered activation state of said at least one downstream component is capable of promoting a therapeutically advantageous network activation state of the biological network, the method comprising:
a) providing a response surface having a plurality of axes, each first such axis having data that relates an activation state of said at least one downstream component with activation states of the first upstream component, each second such axis having data that relates an activation state of said at least one downstream component with activation states of a second upstream component of the biological network, and each nth axis, if present, having data that relates an activation state of said at least one downstream component with activation states of the nth upstream component, if present,
wherein the plurality of axes is equal in number to the number of candidate therapeutic agents to be in the selected combination;
b) providing pharmacologic data describing,
for each member of a first plurality of candidate therapeutic agents, a first data set representing at least one first degree of impact of the member of the first plurality of candidate therapeutic agents on an activation state of the first upstream component,
for each member of a second plurality of candidate therapeutic agents, a second data set representing at least one second degree of impact of the member of the second plurality of candidate therapeutic agents on an activation state of the second upstream component, and
for each member of an nth plurality of candidate therapeutic agents, if present, an nth data set representing at least one nth degree of impact of the member of the nth plurality of candidate therapeutic agents on an activation state of the nth upstream component,
wherein said first and second, and, if present, nth pluralities contain sets of candidate therapeutic agents that may be overlapping or non-overlapping with each other set of candidate therapeutic agents present;
c) mapping the pharmacologic data describing each first degree of impact as a data point on the first axis of the response surface, mapping the pharmacologic data describing each second degree of impact as a data point on the second axis of the response surface, and mapping, if present, the pharmacologic data describing each nth degree of impact as a data point on, the nth axis of the response surface, so that all combinations of first, second, and, if present, nth, data points are mapped as specific sets of response surface coordinates, wherein each specific set of response surface coordinates represents a predicted effect of each corresponding combination of therapeutic agents on the activation state of the downstream component;
d) delineating a defined set of therapeutically advantageous activation states of the downstream component as a contiguous or discontiguous area on the response surface;
e) identifying those combinations of first, second, and, if present, nth candidate therapeutic agents the specific set of response surface coordinates for which map within the contiguous or discontiguous area on the response surface;
wherein, each combination of candidate therapeutic agents so identified is selected as a combination that can act together achieve a network activation state within the defined set.

2. The method of claim 1 wherein the nth upstream component is present as a third component and there are only three components.

3. The method of claim 1 wherein the nth upstream component is present as a third upstream component and a fourth upstream component and there are only four upstream components.

4. The method of claim 1 wherein there is no nth component present, and said all combinations of first and second, data points are mapped as specific response surface coordinates by projecting, from each data point on the first axis of the response surface, a first line that is orthogonal to the first axis; and projecting, from each data point on the second axis of the response surface, a second line that is orthogonal to the second axis, which first and second lines intersect on the response surface so as to generate a plurality of intersections between each orthogonal line from each data point for each member of the first plurality of therapeutic agents and each orthogonal line from each data point for each member of the second plurality of candidate therapeutic agents, wherein each intersection corresponds to a particular pair of candidate therapeutic agents and location of each intersection on the response surface represents a predicted effect of each pair of therapeutic agents on the activation state of the downstream component.

5. The method of claim 1, wherein at least one of the selected combinations is tested in a cell-based assay to determine of it is capable of promoting the therapeutically advantageous network activation state of the biological network.

6. The method of claim 5, wherein the network activation state of the biological network is determined by measuring a cellular property or event indirectly related to the network activation state.

7. The method of claim 5 wherein the therapeutically advantageous network activation state is one that results in inhibition of cell proliferation and the selected combinations are tested in cell-based assays for inhibition of cell proliferation.

8. The method of claim 1, wherein the response surface is a visual response surface or a virtual response surface.

9. The method of claim 1, wherein the data is simulated in a computing system with one or more mathematical models of the biological network.

10. The method of claim 1, wherein the therapeutic agents have a synergistic effect on the activation state of the downstream component.

11. The method of claim 1, wherein the therapeutic agents reduce the activation state of the downstream component below a desired threshold.

12. The method of claim 1, wherein the therapeutically advantageous network activation state is an optimal network activation state.

13. The method of claim 1, wherein the desired network activation state is related to activation, inhibition, phosphorylation, or other modulation of the downstream component.

14. A method as in claim 1, wherein the altered activation state of the downstream component that is capable of promoting a therapeutically advantageous network activation state of the biological network is an activation state located down a steepest gradient on the response surface.

15. The method of claim 1, wherein the response surface is symmetric.

16. The method of claim 1, wherein the response surface is asymmetric.

17. The method of claim 1, wherein the plurality of candidate therapeutic agents are part of a library of compounds.

18. The method of claim 4, further comprising, prior to mapping the pharmacologic data on the response surface, providing a mathematical model that is capable of simulating the effects of the candidate therapeutic agents on the first and second upstream components, said mathematic model including at least one avidity criterion as a parameter to join each pair of candidate therapeutic agents; wherein, for each avidity criterion included in the model, each pair of candidate therapeutic agents so identified is selected as a pair that can act together in a bispecific molecule to achieve a network activation state within the defined set.

19. The method of claim 18, wherein at least one pair of the selected combinations is tested as a bispecific molecule in a cell-based assay to determine of the bispecific molecule is capable of promoting the therapeutically advantageous network activation state of the biological network.

20. A method as in claim 19, wherein both the first and second candidate therapeutic agents together are modulators, activators, or inhibitors to one or more of the first or second upstream components.

21. A method as in claim 19, wherein each candidate therapeutic agent is selected from the group consisting of small molecules, polypeptides, polynucleotides, siRNA, antibodies, Fabs, ScFvs, proteins, genes, bispecifics thereof, and combinations thereof.

22. A method as in claim 19, wherein the bispecific molecule comprises the first candidate therapeutic agent and the second candidate therapeutic agent coupled together through a linker.
